(19) United States
(12) Patent Application Publication
(10) Pub. No.: US 2020/0167757 A1
(43) Pub. Date: May 28, 2020

(54) METHOD AND SYSTEM FOR PROCESSING A TRANSACTION USING PLURALITY OF DEVICES

(71) Applicant: MASTERCARD ASIA/PACIFIC PTE. LTD., Singapore (SG)

(72) Inventors: Anupam Sharma, Singapore (SG); Tobias Puehse, Singapore (SG); Donghao Huang, Singapore (SG); Bensam Joyson, Singapore (SG)

(73) Assignee: MASTERCARD ASIA/PACIFIC PTE. LTD., Singapore (SG)

(21) Appl. No.: 16/678,324

(22) Filed: Nov. 8, 2019

(30) Foreign Application Priority Data
Nov. 28, 2018 (SG) 10201810650Y

(51) Int. Cl. G06Q 20/24; G06Q 20/32; H04L 29/08; H04W 76/10

(52) U.S. Cl. CPC G06Q 20/24; H04W 76/10; H04L 67/306; G06Q 20/3223

(57) ABSTRACT

The present disclosure provides a server for processing a transaction using a plurality of devices. The server comprises at least one processor; and at least one memory including computer program code. The at least one memory and the computer program code configured to, with the at least one processor, cause the server at least to receive, from a second device, a request to continue with the transaction, the transaction being initiated and postponed by a first device. The server is then configured to determine whether the second device is associated with a user account that is associated with the first device; and transmit, to the second device, details relating to the postponed transaction based on the determination of whether the second device is associated with the user account to enable the second device to further process the transaction.

### TECHNICAL FIELD

The present invention relates generally to payment technology and, in particular, to provide a method and system for processing a transaction across a plurality of devices.

### BACKGROUND

Often, a user will begin a transaction but cannot complete the purchase process. For example, a user may be at a store and undecided about whether he indeed wants to make the purchase. In another example, a user may need to get permission from family members to finalize the purchase. In another example, the user starts an online transaction but does not have enough time to finish a purchase, for example the user has only limited time because of an appointment to which the user has to attend.

Sometimes, a user wishing to purchase the products must return to the store to complete the purchase. However, there are times when a user may not be able to do so. For example, the user is a tourist in New York and is thinking of buying a suit at a store. The user then brings the suit to a point-of-sale terminal of the store. However, the user cannot complete the transaction, for example because the user is unable to make payment or the user is undecided whether to purchase the suit. The user then leaves the store without purchasing the suit. For some reasons, the user cannot return to the store to complete the purchase process before leaving New York. In this situation, the merchant has lost the opportunity to make a sale and the user has lost the opportunity to purchase a suit that he wants.

In another example, a user may start an online purchase process using one of the devices that the user owns. For some reasons, the user cannot complete the purchase process on the device. If the user then uses another device to complete the purchase process, the user must then restart the purchase process as the other device would not have any details regarding the unfinished purchase process. The user may then get frustrated with repeating what he had previously done on his other device and may decide to stop the purchase process, resulting in the merchant losing an order from the user.

### SUMMARY

Disclosed are arrangements which seek to address the above problem by providing a transaction processing server for processing a transaction such that the transaction can be initiated by a first device, postponed, and completed by a second device. When a transaction is initiated by a user, the transaction processing server generates a transaction and associates the transaction with a user account of the user. When a user cannot complete/finalize the transaction on a first device (e.g., a merchant device, a transaction device, etc.), then the user can request the transaction to be postponed. Upon receipt of the postponement request, the transaction processing server stores the details of the transaction and the associated user account. The user can then complete the transaction using a second device (e.g., a transaction device) by accessing the user account, selecting the relevant postponed transaction, and completing the transaction.

According to a first aspect of the present disclosure, there is provided a server for processing a transaction using a plurality of devices, the server comprising: at least one processor; and at least one memory including computer program code; the at least one memory and the computer program code configured to, with the at least one processor, cause the server at least to: receive, from a second device, a request to continue with the transaction, the transaction being initiated and postponed by a first device; determine whether the second device is associated with a user account that is associated with the first device; and transmit, to the second device, details relating to the postponed transaction based on the determination of whether the second device is associated with the user account to enable the second device to further process the transaction.

According to a second aspect of the present disclosure, there is provided a method of processing a transaction using a plurality of devices, the method comprising: receiving, from a second device, a request to continue with the transaction, the transaction being initiated and postponed by a first device; determining whether the second device is associated with a user account that is associated with the first device; and transmitting, to the second device, details relating to the postponed transaction based on the determination of whether the second device is associated with the user account to enable the second device to further process the transaction.

According to another aspect of the present disclosure, there is provided an apparatus for implementing any one of the aforementioned methods.

According to another aspect of the present disclosure, there is provided a computer program product including a computer readable medium having recorded thereon a computer program for implementing any one of the methods described above.

Other aspects are also disclosed.

### BRIEF DESCRIPTION OF THE DRAWINGS

At least one embodiment of the present invention will now be described with reference to the drawings and appendices, in which:

FIG. 1A shows a system for processing a transaction across a plurality of devices;

FIGS. 1B to 1D show alternative embodiments of the system shown in FIG. 1A;

FIG. 2 is a flow diagram of a method of initiating a transaction using a first device in the system shown in FIG. 1;

FIG. 3 is a flow diagram of a method of completing a transaction that has been postponed using a second device in the system shown in FIG. 1;

FIG. 4A is a flow diagram of a sub-process of determining whether a device initiating a transaction in the system of FIG. 1 is associated with a user account;

FIG. 4B is a flow diagram of a sub-process of determining whether a device requesting to continue with a postponed transaction in the system of FIG. 1 is associated with a user account;

FIG. 5 is a flow diagram of a sub-process of postponing a transaction in the system of FIG. 1,

FIGS. 6A and 6B form a schematic block diagram of a general purpose computer system upon which the transaction processing server of FIG. 1 can be practiced; and

FIG. 7 shows an example of a computing device to realize the transaction processing server shown in FIG. 1.

### DETAILED DESCRIPTION INCLUDING BEST MODE

### Terms Description

Payment Network Server—The payment network server is a server that hosts software application programs for processing payment of a transaction request message. The payment network server is a typical payment network server that is used to process transaction request messages. The payment network server communicates with a token server (if required), and any other servers (e.g., an issuer server, an acquirer server) to facilitate payment of transaction request messages generated by the transaction processing server 110. Payment network servers may use a variety of different protocols and procedures in order to process the transaction request messages. Transactions that may be performed via a payment network server include product or service purchases, credit purchases, debit transactions, fund transfers, account withdrawals, etc. Payment network servers may be configured to process transactions via cash-substitutes, which may include payment cards, letters of credit, checks, payment accounts, etc. The payment network server is operated by a service provider such as Mastercard®. For example, the payment network server may be Banknet network operated by Mastercard. The service provider (e.g. Mastercard) may be an entity (e.g. a company or organization) who operates to process transactions, clear and settle funds for payments between two entities (e.g. two banks). The payment network server may include one or more computing devices that are used for processing transactions.

A user account—an account of a registered user. The user account can be used to process a transaction, in particular to enable the transaction to be initiated and postponed on a first device and completed on a second device. The user account may include a payment account of the registered user.

The user account is also associated with a list of devices. The devices listed in this list is called trusted devices. Devices not in the list (which will be called non-trusted devices hereinafter) can also be associated with (or paired with) the user account temporarily once a trusted device authorizes a non-trusted device to be associated with (or paired with) the user account.

A trusted device—a device associated with a user account. A trusted device is approved to use the user account to process a transaction.

A non-trusted device—a device that is not associated with a user account. A non-trusted device is not approved to use the user account to process a transaction. For a non-trusted device to use the user account to process a transaction, a trusted device associated with the user account must authorize the non-trusted device to be paired temporarily with the user account. Once paired, the non-trusted device can use the user account to process a transaction. Once the transaction is postponed or completed, the non-trusted device is unpaired or disassociated from the user account.

Transaction—A transaction relates to an agreement carried out between a customer and a merchant to exchange asset (i.e., goods or services) for payment. A transaction can be divided into three stages: 1. Initiation of the transaction; 2. Postponing of the transaction; and 3. Completion of the transaction. A transaction is initiated by a trusted device or a non-trusted device. The transaction may then be postponed. The postponed transaction may also be modified. The postponed transaction can then be completed by a device other than the device initiating the transaction.

Hereinafter, the phrase “performing a transaction” refers to carrying out any one of the three stages of transaction, either alone or together with one or more other stages of the transaction.

A postponed transaction—A transaction that has been postponed. The transaction is postponed and stored to enable a trusted device or a non-trusted device to complete the transaction at a later time. A transaction can be postponed when there are insufficient details (e.g., a user approval, transaction credentials, etc.) to complete the transaction.

A completed transaction—A transaction that has sufficient details (e.g., a user approval, transaction credentials, etc.) to generate a transaction request message. The transaction request message can then be forwarded to an acquirer server, the payment network server, and an issuer server, such that payment of the transaction request message can be facilitated.

Payment Account—A payment account that is used to provide or receive fund for a transaction. Examples of a payment account are a check account, a savings account, a credit account, a virtual payment account, a payment card, and the like. The payment card refers to any suitable transaction cards, such as credit cards, debit cards, prepaid cards, charge cards, membership cards, promotional cards, frequent flyer cards, identification cards, gift cards, and/or any other device that may hold payment account information, such as mobile phones, Smartphones, personal digital assistants (PDAs), key fobs, and/or computers.

A payment account is associated with either a customer or a merchant. A payment account associated with a customer is issued by an issuer in a transaction. On the other hand, a payment account associated with a merchant is issued by an acquirer in a transaction.
In some instances, a payment account may be virtual, such as those accounts operated by PayPal, Mastercard, etc.

User—a user may be any suitable type of entity associated with a payment account, which may include a person, family, company, corporation, governmental entity, and the like. The term user is used herein to identify an entity performing or approving a purchase in a transaction. The user may provide the fund for the transaction.

Merchant—a merchant may be any suitable type of entity associated with a payment account, which may include a person, family, company, corporation, governmental entity, and the like. The term merchant is used herein to identify an entity performing a sale in a transaction and receiving the fund for the transaction.

Transaction credentials—Transaction credentials are credentials provided by either a user or a merchant to perform a transaction. Examples of the transaction credentials include a payment account, a password associated with the payment account, and any other data that an acquirer provider or an issuer provider need to authorize a transaction request message generated from the transaction.

### EXAMPLE IMPLEMENTATIONS

Where reference is made in any one or more of the accompanying drawings to steps and/or features, which have the same reference numerals, those steps and/or features have for the purposes of this description the same function(s) or operation(s), unless the contrary intention appears.

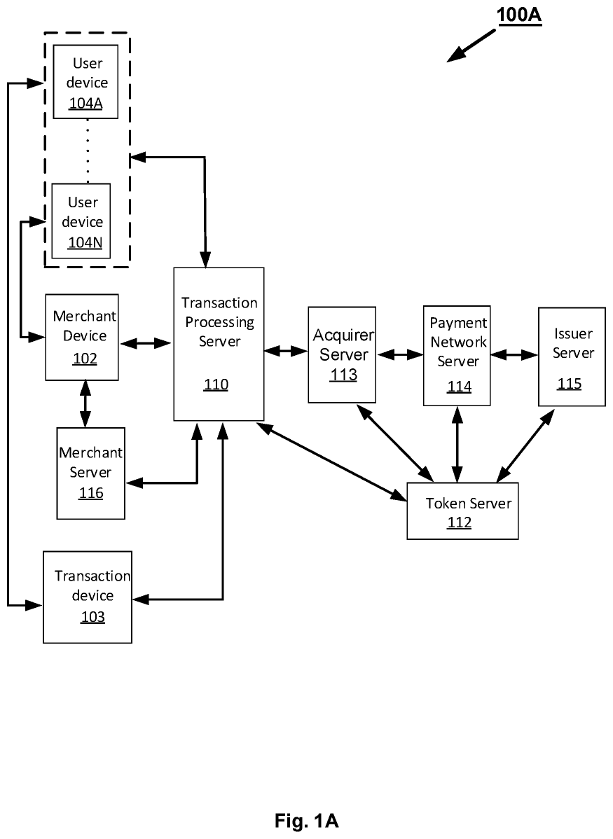

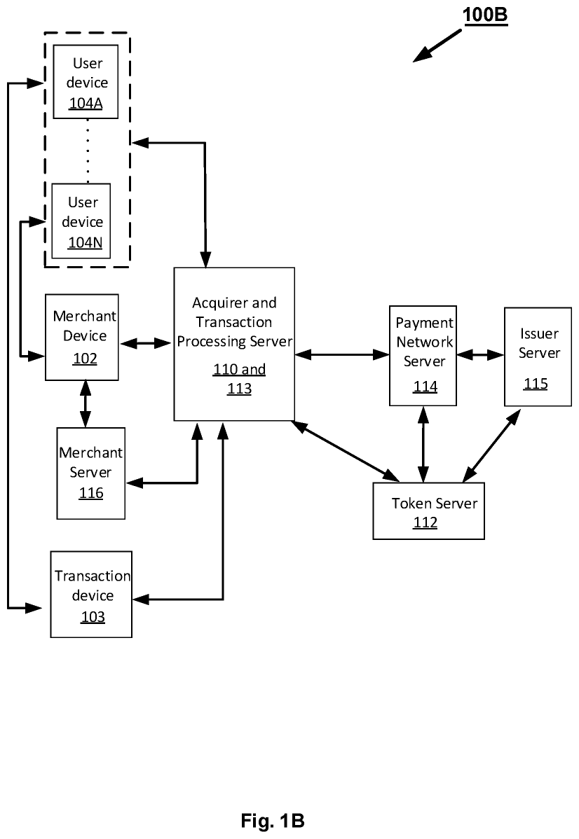

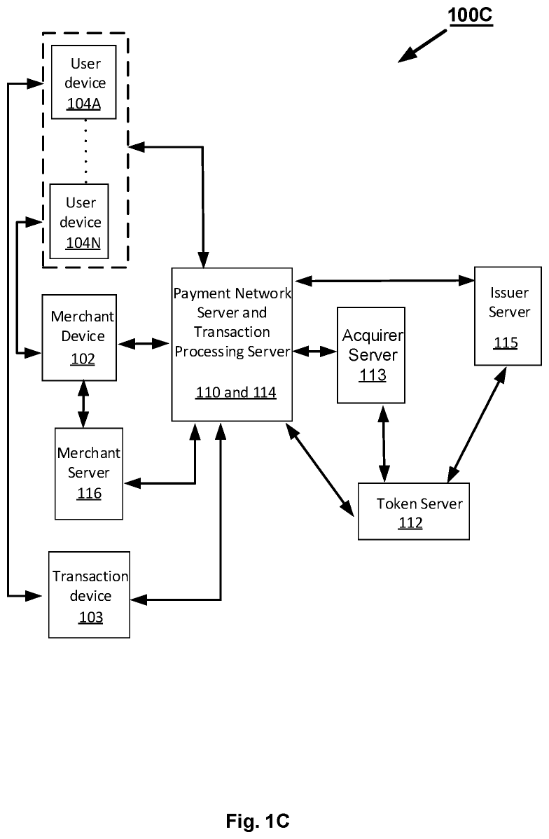

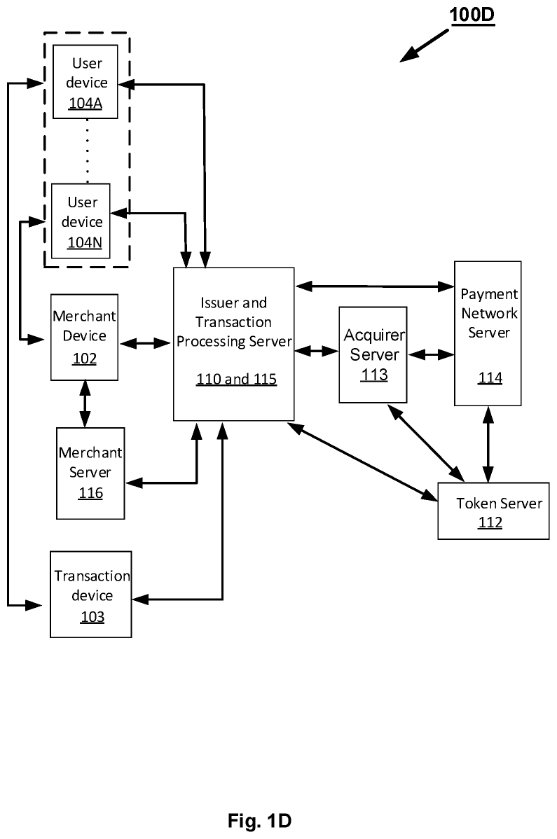

FIG. 1A shows a system 100A comprising user devices 104A to 104N, a merchant device 102, a transaction device 103, a merchant server 116, an acquirer server 113, a payment server 114, an issuer server 115, a token server 112, and a transaction request message processing server 110.

### The Transaction Processing Server 110

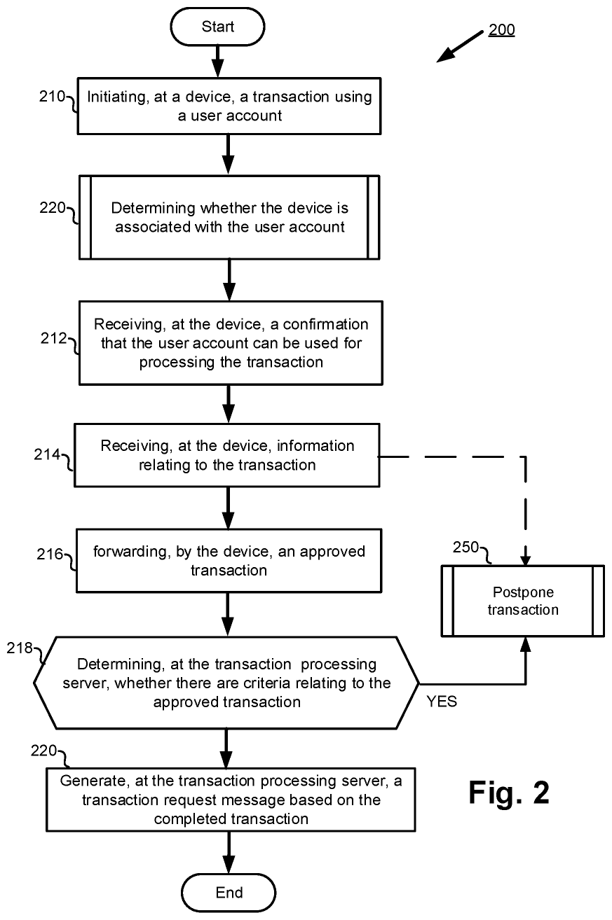

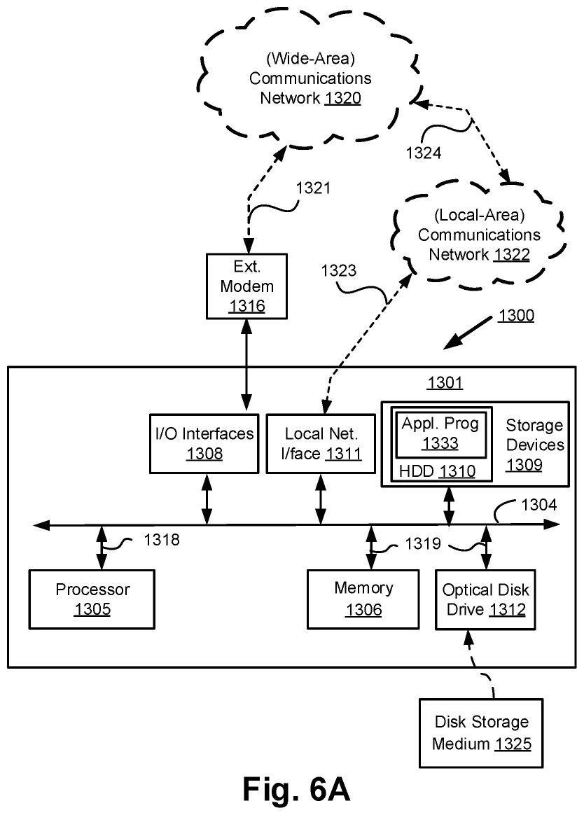

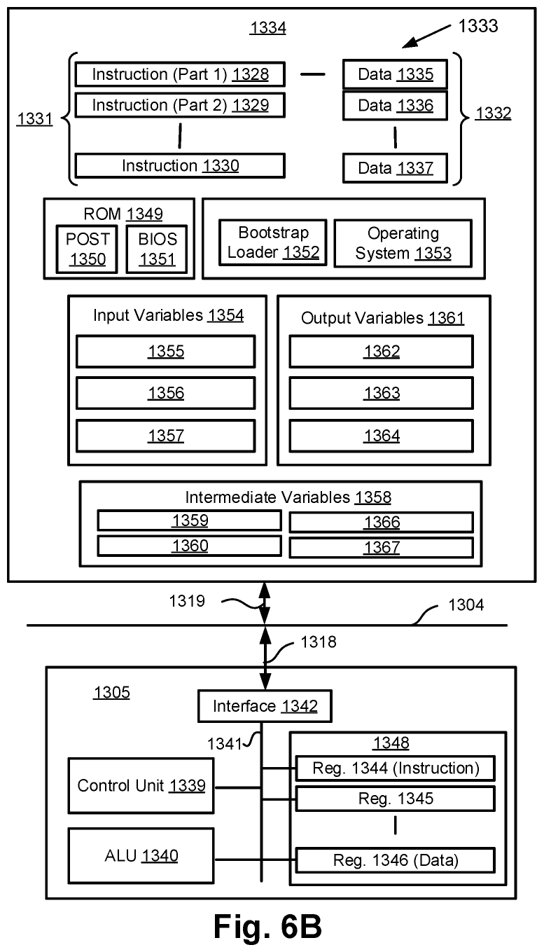

The transaction processing server 110 is a server that hosts software application programs 1333 (see FIGS. 6A and 6B) to manage user accounts belonging to respective users and transactions. Functions of the transaction processing server 110 will be discussed below in more detail in relation to FIGS. 2 to 4. The structural context of the transaction processing server 110 is discussed below in relation to FIGS. 6A and 6B.

In the illustrative embodiment, the transaction processing server 110 provides an interface to enable communication with each of the devices 104A to 104N, 103, and 102 and the servers 112, 113, 116. The transaction processing server 110 is shown in FIGS. 1A to 1D to be connected to the collective user devices 104A to 104N for simplicity sake. The transaction processing server 110 is connected to any one of the user devices 104A to 104N.

The transaction processing server 110 provides an application programming interface (“API”) to facilitate such communication. Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. Examples of APIs include the Representational State Transfer (REST) API, and the like.

The transaction processing server 110 stores and manages user accounts of users that are registered to use the services provided by the transaction processing server 110. The transaction processing server 110 provides a service to enable a user to process (i.e., initiate, postpone, complete) a transaction using multiple devices. To enable such a transaction, the transaction processing server 110 uses a user account to manage the transaction such that the transaction can be postponed and completed at a later time. Further, the transaction can be initiated by a first device and completed by a second device. The method of postponing and completing a transaction using multiple devices will be described hereinafter.

In an alternative arrangement, the transaction processing server 110 is part of a payment network server 114 (as shown in FIG. 1C). For example, the transaction processing server 110 may also be a payment network server 114 that is configured to facilitate payment between a user of the user devices 104A to 104N or the transaction device 103 and a merchant of the merchant device 102.

In another alternative arrangement, the transaction processing server 110 is part of an acquirer server 113 (as shown in FIG. 1B) or part of an issuer server 115 (as shown in FIG. 1D).

In one arrangement, the transaction processing server 110 is compatible with existing payment apps such as Masterpass, Qkr!, payment gateways (such as Mastercard Payment Gateway Service), and the like. In another arrangement, the transaction processing server 110 is an additional function on a payment app like Masterpass or Qkr!.

### The Merchant Server 116

The merchant server 116 is a server that hosts software application programs to manage the user accounts belonging to respective users. The merchant server 116 performs this function simultaneously with the transaction processing server 110 to improve the security of the user account and to store merchant specific information of the user account. For example, the user account stored in the merchant server 116 may contain information regarding favourite items and/or services that the user frequently purchases from the merchant. In another example, the user account in the merchant server 116 may contain information regarding items and/or services that the user wishes the merchant to provide. The merchant server 116 connects with the transaction processing server 110. As discussed above, the merchant server 116 communicates with the transaction processing server 110.

In one alternative arrangement, the merchant server 116 can be integrated in the transaction processing server 110.

The merchant server 116 also hosts software application programs to manage goods and/or services that a merchant sells. Any of the devices 102, 103, 104A to 104N can access the merchant server 116, via the transaction processing server 110, to review and select products and/or services that are offered by a merchant. There are other merchant servers 116 associated with respective merchants, but these other merchant servers 116 are not shown for ease of description.

In one arrangement, the merchant server 116 also connects to the merchant device 102 to enable the merchant device 102 to retrieve details of products and/or services offered by the merchant.

The merchant server 116 is accessible by any of the devices 102, 103, 104 via the transaction processing server 110.

### The Merchant Device 102

The merchant device 102 is a non-trusted device belonging to a merchant. The merchant device 102 is used to perform a transaction. The merchants offer goods and/or services. Examples of the merchant device 102 are tablets, laptops, desktop computers, smartphones, point-of-sales terminals, an interactive robot, and the like. The merchant device 102 connects with the transaction processing server 110. As described above, the merchant device 102 can communicate with the transaction processing server 110.

The present disclosure only shows one merchant device 102 for ease of description. However, there may be multiple merchant devices 102 associated with a merchant. There are also multiple merchants (not shown) in the system 100.

A user can use the merchant device 102 to initiate or complete a transaction to purchase goods and/or services using a user account, once the merchant device 102 is authorized to be paired temporarily with the user account. Such an authorization is performed by a trusted device of the user account. The merchant device 102 may be located at a store owned by the merchant.

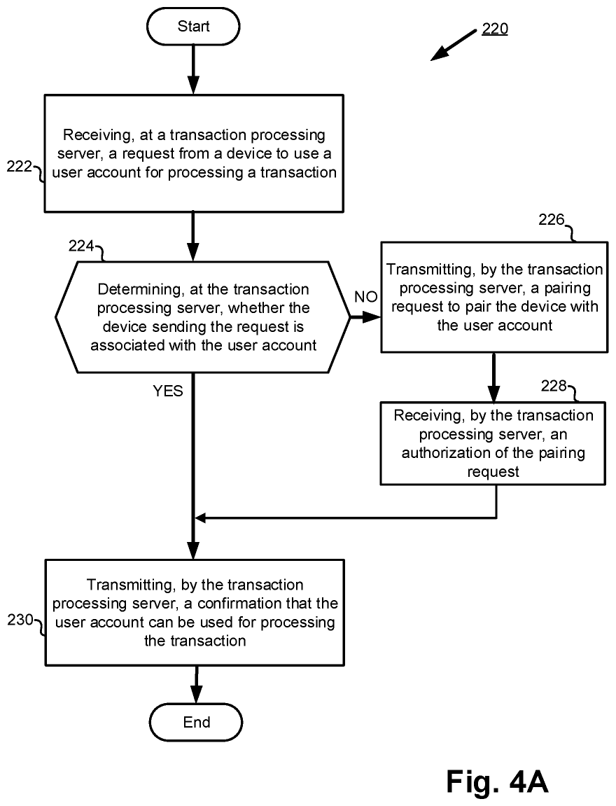

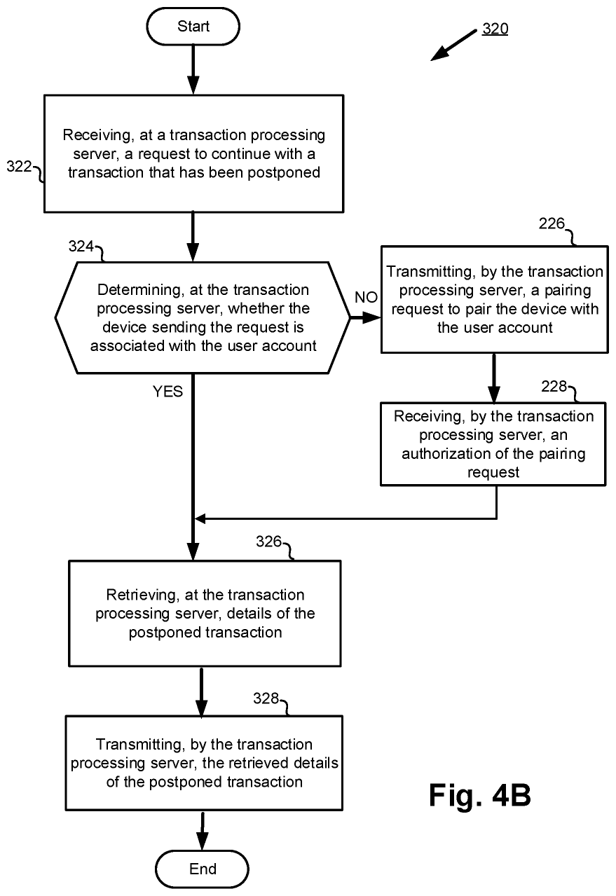

The merchant device 102 may also be connected to any one of the user devices 104A to 104N to receive an authorization code for a pairing request. The receiving of the authorization code is described below in relation to step 226 (see FIGS. 4A and 4B). The merchant device 102 is shown in FIGS. 1A to 1D to be connected to the collective user devices 104A to 104N for simplicity sake.

### The Transaction Device 103

The transaction device 103 is a non-trusted device belonging to a third party or a user. For example, the transaction device 103 is owned by a family member or a friend of the user. In another example, the transaction device 103 is owned by the user but has not been included in the user account as a trusted device. One reason may be because the transaction device 103 is typically used by a child of the user and the user does not want the transaction device 103 to be inadvertently used to perform a transaction.

The transaction device 103 can be used by a user to conduct a transaction (e.g., purchase goods and/or services from a merchant). Examples of the transaction device 103 are tablets, laptops, desktop computers, smartphones, smart speakers, an interactive robot, and the like. The transaction device 103 connects with the transaction processing server 110. As described above, the transaction device 103 can communicate with the transaction processing server 110.

The present disclosure only shows one transaction device 103 for ease of description. However, there may be multiple transaction devices 103. The transaction device 103 is not a device that is listed as a trusted device in the user account of the user (see the on-boarding section below for discussions on a trusted device).

A user can use the transaction device 103 to initiate or complete a transaction to purchase goods and/or services using the user account, once the transaction device 103 is authorized to be paired temporarily with the user account. Such an authorization of the pairing is performed by a trusted device of the user account.

The transaction device 103 may also be connected to any one of the user devices 104A to 104N to receive an authorization code for a pairing request. The receiving of the authorization code is described below in relation to step 226 (see FIGS. 4A and 4B). The transaction device 103 is shown in FIGS. 1A to 1D to be connected to the collective user devices 104A to 104N for simplicity sake.

### The User Devices 104A to 104N

The user devices 104A to 104N are devices that belong to a user who is registered with the transaction processing server 110. Such a user has a user account with the transaction processing server 110. The registration (i.e., on-boarding) of the user with the transaction processing server 110 is described below.

Any of the user devices 104A to 104N can be assigned as a trusted device in the user account (described below in relation to the on-boarding of the user). A trusted device is enabled to use the user account to initiate and complete transactions. A trusted device can also be used by a user to temporarily pair a merchant device 102 or a transaction device 103 with the user account to process (i.e., initiate, postpone, complete) a transaction such that the user account is used for the transaction. The pairing of a merchant device 102 with a user account will be described below in relation to FIG. 4.

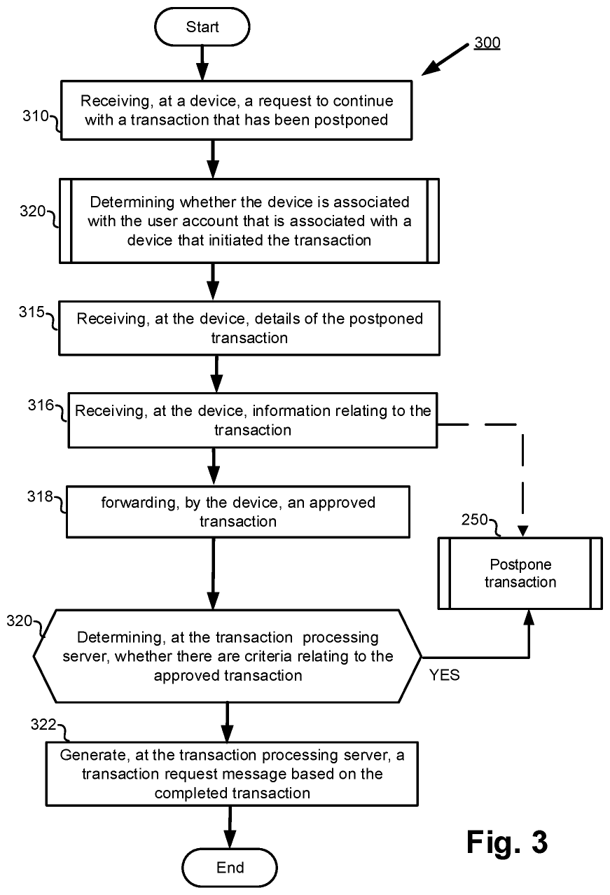

Any of the user devices 104A to 104N can also be used to complete a transaction that has been postponed. The method of completing a postponed transaction is described below in relation to FIG. 3.

Examples of the user devices 104A to 104N are tablets, laptops, desktop computers, smartphones, smart speakers, and the like. The user devices 104A to 104N respectively connect with the transaction processing server 110. Hereinafter, the user devices 104A to 104N are collectively referred to as the user devices 104 (when referring to all of the user devices) and the user device 104 (when referring to a single user device). As described above, the user devices 104 can communicate with the transaction processing server 110.

The terms “user devices 104” and “trusted user devices 104” refer to devices that are registered with a user account and are approved to process a transaction using the user account that the user devices 104 are associated with. The user devices 104 can initiate, postpone, or complete a transaction using the user account without further approval from another trusted user device 104. Therefore, the terms “user devices 104” and “trusted user devices 104” are used interchangeably in the present disclosure. The user devices 104 are also referred to as devices that are associated with a user account.

As described above, any of the user devices 104 may connect to the merchant device 102 or the transaction device 103 to provide an authorization code for a pairing request. The provision of the authorization code to the merchant device 102 or the transaction device 103 is discussed below in relation to step 226 (see FIGS. 4A and 4B).

### The Acquirer Server 113

The acquirer server 113 is a server that hosts software application programs for receiving transaction request messages, which are associated with completed transactions, from the transaction processing server 110 and forwarding the received transaction request messages to the payment network server 114.

The acquirer server 113 is connected to the transaction processing server 110 to receive the transaction request messages. The acquirer server 113, in turn, is in communication with the payment network server 114.

The acquirer server 113 generally is associated with an acquirer who may be an entity (e.g. a company or organization) which issues (e.g. establishes, manages, administers) a payment account (e.g. a financial bank payment account) of the merchant. Examples of the acquirer include a bank and/or other financial institution. The acquirer server 113 may include one or more computing devices that are used to establish communication with another server by exchanging messages with and/or passing information to the other servers 110 and 114.

### The Payment Network Server 114

The payment network server 114 is a server that hosts software application programs for processing payment of transactions. The payment server 114 is a typical payment network server that is used to process transaction request messages. The payment network server 114 is connected to the acquirer server 113 to receive transaction request messages. The payment network server 114 also communicates with the token server 112 (if required) to tokenize any transaction request messages received from the acquirer server 113. The payment network server 114 is also connected to the issuer server 115 to forward the received transaction request messages to the issuer server 115. The payment network server 115 then receives authorization responses to the forwarded transaction request messages from the issuer server 115.

### The Issuer Server 115

The issuer server 115 is a server that hosts software application programs for receiving transaction request messages from the payment network server 114, processing the transaction request messages, and transmitting authorization responses to the respective transaction request messages to the payment network server 114.

The issuer server 115 is connected to the payment network server 114 to receive the transaction request messages.

The issuer server 115 generally is associated with an issuer and may include one or more computing devices that are used to process a transaction request message. The issuer may be an entity (e.g. a company or organization) which issues (e.g. establishes, manages, administers) a payment account (e.g. a financial bank payment account) of a user.

### The Token Server 112

The token server 112 is a server that hosts software application programs for tokenizing data. The data may relate to a payment account of a user or a merchant, a transaction, a user account, and the like. The token server 112 connects with the transaction processing server 110, the acquirer server 113, the payment network server 114, and the issuer server 115. Therefore, the transaction processing server 110, the acquirer server 113, the payment network server 114, and the issuer server 115 can connect to the token server 112 to request data to be tokenized by the token server 112.

The token server 112 may be operated by a third party or an institution (e.g., a bank).

### Function of the System 100A

The system 100A enables a transaction to be initiated by a first device (e.g., the user devices 104, the merchant device 102, the transaction device 103) using the transaction processing server 110. The first device can then postpone the transaction. A second device (e.g., the user devices 104, the merchant device 102, the transaction device 103) can then continue the postponed transaction using the transaction processing server 110. The second device can then complete the transaction.

Once the transaction is completed, the transaction processing server 110 generates a transaction request message and transmits the transaction request message to the acquirer server 113. The acquirer server 113 then forwards the transaction request message to the payment network server 114. The payment network server 114, in turn, forwards the transaction request message to the issuer server 115. The issuer server 115 either approves or denies the transaction request message and transmits an authorization message (with either approval or denial of the transaction request message) to the payment network server 114. The payment network server 114 then forwards the authorization message to the acquirer server 113.

The process of using the system 100A will be described below in more detail in relation to FIGS. 2 to 5.

### Alternative Implementations

FIG. 1B shows an alternative implementation of system 100B where the transaction processing server 110 is integrated with the acquirer server 113. The functionality of each component of the system 100B is similar to the functionality of the corresponding component of the system 100A. However, the integrated acquirer and transaction processing server 113 and 110 performs the functions of both the acquirer server 113 and the transaction processing server 110. In particular, the initiating, postponing, and completing a transaction is as described herein.

Similar to the system 100A, the integrated server 110 and 113 transmits the generated transaction request message to the payment network server 114.

The payment network server 114, in turn, forwards the transaction request message to the issuer server 115. The issuer server 115 either approves or denies the transaction request message and transmits an authorization message (with either approval or denial of the transaction request message) to the payment network server 114. The payment network server 114 then forwards the authorization message to the integrated server 110 and 113.

FIG. 1C shows an alternative implementation of system 100C where the transaction processing server 110 is integrated with the payment network server 114. The functionality of each component of the system 100C is similar to the functionality of the corresponding component of the system 100A. However, the integrated payment network and transaction processing server 114 and 110 performs the functions of both the payment network server 114 and the transaction processing server 110. In particular, the initiating, postponing, and completing a transaction is as described above for system 100A.

Similar to the system 100A, the integrated server 110 and 114 transmits the generated transaction request message to the acquirer server 113.

The transaction request message is then transmitted from the acquirer server 113 to the integrated server 110 and 114. The integrated server 110 and 114, in turn, forwards the transaction request message to the issuer server 115. The issuer server 115 either approves or denies the transaction request message and transmits an authorization message (with either approval or denial of the transaction request message) to the integrated server 110 and 114. The integrated server 110 and 114 then forwards the authorization message to the acquirer server 113.

FIG. 1D shows an alternative implementation of system 100D where the transaction processing server 110 is integrated with the issuer server 115. The functionality of each component of the system 100D is similar to the functionality of the corresponding component of the system 100A. However, the integrated issuer and transaction processing server 115 and 110 performs the functions of both the issuer server 115 and the transaction processing server 110. In particular, the initiating, postponing, and completing a transaction is as described above for system 100A.

Similar to the system 100A, the generated transaction request message is transmitted from the integrated server 110 and 115 to the acquirer server 113.

The transaction request message is then transmitted from the acquirer server 113 to the payment network server 114. The payment network server 114, in turn, forwards the transaction request message to the integrated server 110 and 115. The integrated server 110 and 115 either approves or denies the transaction request message and transmits an authorization message (with either approval or denial of the transaction request message) to the payment network server 114. The payment network server 114 then forwards the authorization message to the acquirer server 113.

Hereinafter, for ease of description, the transaction processing server 110 will be described in relation to the system 100A. However, as will be understood by a person skilled in the art, the functions of the transaction processing server 110 can be performed by any of the integrated servers shown in FIGS. 1B to 1D.

Hereinafter, the systems 100A, 100B, 100C, and 100D will be collectively referred to as the system 100.

### On-Boarding of Users and Merchants

Before a user can use the transaction processing server 110, the user must register with the transaction processing server 110. The registration step is called on-boarding.

The on-boarding process for a user is performed by the user through one of the user devices 104. In one arrangement, the user downloads an app relating to the transaction processing server 110 to the user device 104. In another arrangement, the user accesses a website relating to the transaction processing server 110 on the user device 104. As described below in relation to FIGS. 6A and 6B, the API is part of the software application program 1333. Once the user accesses the app or website on the user device 104, the user is able to interact with the transaction processing server 110 to register.

Details of the registration include, for example, a unique name of the user account, name of the user, transaction credentials (e.g., user payment account, an authorization to use the payment account, etc.), user devices 104 that are classified as trusted devices, and the like. In one arrangement, a unique identifier (e.g., MAC address, CPU serial number, etc.) of the trusted user devices 104 are associated with the user account. Once on-boarded, the transaction processing server 110 creates a user account for the user. The unique name of the user account can be used to refer to the user account quickly when performing a transaction.

In one arrangement, it may be possible for a user to create multiple user accounts on the transaction processing server 110.

In one arrangement, the user account does not store the transaction credentials. In this arrangement, the transaction credentials are entered by the user when purchasing goods and/or services from a merchant.

Trusted user devices 104 are then capable of authorizing/approving pairing between the user account and a merchant device 102 or a transaction device 103 via the transaction processing server 110. Trusted user devices 104 are also capable of initiating, postponing, and completing transactions using the user account. In one arrangement, the user may set specific trusted user devices 104 to use for such authorizing/approving in the user account.

In one alternative arrangement, a user can use an existing user account, which is issued by an issuer (e.g., a bank, a financial institution, etc.) or an entity (e.g., Mastercard, etc.), to use the transaction processing server 110. In this alternative arrangement, the transaction processing server 110 can connect into the core user management system of the issuer to enable the user to utilise the transaction processing server 110. Further, in this alternative arrangement, the user can use a Secure Remote Commerce (SRC) compatible app such as Masterpass to access the transaction processing server 110.

In one arrangement, a user token is generated upon creation of the user account so that the details of the user payment account are not stored on the transaction processing server 110. The user token is generated by the transaction processing server 110 transmitting details of the user account to the token server 112, the token server 112 tokenizing the details of the user account, and transmitting the user token to the transaction processing server 110.

### Initiating a Transaction

FIG. 2 shows a method 200 of initiating a transaction. The method 200 enables a first device (i.e., devices 102, 103, or 104) to initiate a transaction using a user account and to either postpone the transaction or complete the transaction.

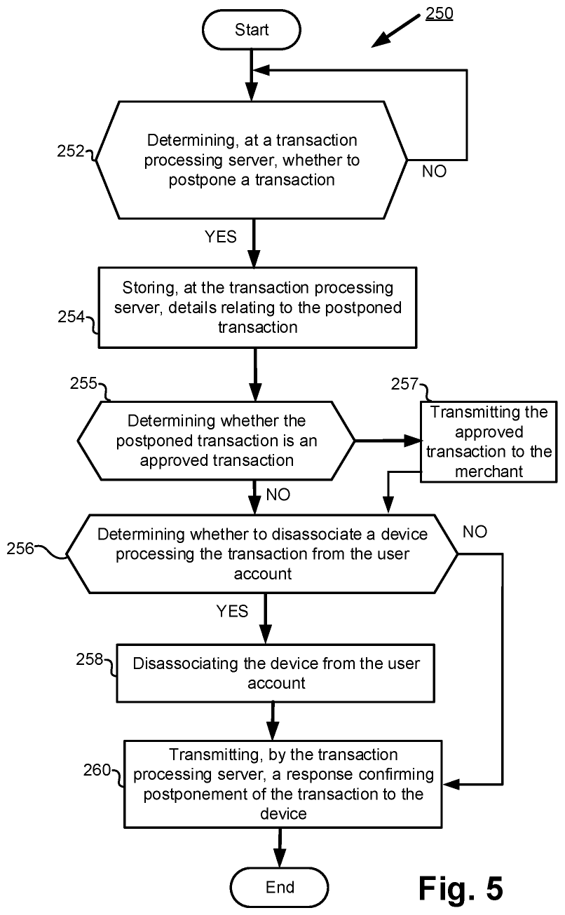

If the transaction is initiated by a non-trusted device 102 or 103, the non-trusted device 102 or 103 is temporarily paired with the user account (see steps 224, 226, and 228 of sub-process 220 shown in FIG. 4A). Once the transaction is postponed or completed, the non-trusted device 102 or 103 is unpaired or disassociated from the user account at the respective step 258 (see FIG. 5) or step 216 (see FIG. 2).

The method 200 commences at step 210 where a transaction using a user account is initiated at a first device (i.e., the merchant device 102, the transaction device 103, or the user device 104).

In step 210, the device 102, 103, 104 initiates a transaction using a user account. The transaction is initiated in response to user input. Examples of the user input include scanning a tag of an item, selecting an item to purchase, requesting to generate a transaction, and the like.

For example, a user can bring an item or a tag associated with an item to a merchant device 102 (e.g., a point-of-sale terminal) to purchase the item. The merchant device 102 is then used to scan the item or tag. The merchant device 102 then accesses the merchant server 116, either directly or via the transaction processing server 110, to determine the availability of the items and/or services to be purchased. Once it is determined that the item and/or services is available, the point-of-sale terminal initiates a transaction relating to the purchase of the item and/or services. The item may be a digital program or file.

In another example, a user can use either the user device 104 or the transaction device 103 to initiate a transaction. The user device 104 or the transaction device 103 can be used to access the merchant server 116 (associated with a merchant), via the transaction processing server 110, to review goods and/or services that the merchant offers. The user can then use the user device 104 or the transaction device 103 to select goods and/or services to purchase. Once the goods and/or services are selected, the user device 104 or the transaction device 103 initiates a transaction relating to the purchase of the selected goods and/or services.

The device 102, 103, or 104 then prompts the user to enter a user account to be used with the initiated transaction. The user can then enter the user account. In one arrangement, the user enters the unique name of the user account. In the above examples, the user enters a user account that has the user devices 104 listed as trusted devices.

The device 102, 103, or 104 then sends, to the transaction processing server 110, a request to use the user account for the initiated transaction. A unique identifier of the device 102, 103, 104 is also sent with the request to enable the transaction processing server 110 to perform sub-process 220.

The method 200 proceeds from step 210 to sub-process 220.

Sub-process 220 determines whether a device 102, 103, 104 used to initiate the transaction is a trusted device associated with the user account. In other words, sub-process 220 determines whether the device used to initiate the transaction is a trusted device of the user account. Sub-process 220 is described below in relation to FIG. 4A.

If the user device 104 is used to initiate the transaction, sub-process 220 returns a confirmation that the transaction may proceed using the user account.

If the transaction device 103 or the merchant device 102 is used to initiate the transaction, sub-process 220 performs an authorization to temporarily pair the transaction device 103 or the merchant device 102 with the user account entered in step 210. Such an authorization is performed by a trusted device 104 and is described in detail below in relation to FIG. 4A. Once paired, sub-process 220 returns a confirmation that the transaction may proceed using the user account.

The transaction device 103 or the merchant device 102 is unpaired or disassociated from the user account when the transaction is further postponed (see step 258 in FIG. 5) or completed (see step 216 in FIG. 2).

The method 200 then proceeds from sub-process 220 to step 212.

In step 212, the device 102, 103, or 104 receives the confirmation that the transaction can be processed using the user account. The method 200 proceeds from step 212 to step 214.

In step 214, the device 102, 103, or 104 receives information relating to the transaction. The information can be transaction credentials, other goods and/or services to be purchased, delivery address, and the like. The transaction may include, among other information, the following: (1) a unique transaction name; (2) goods and/or services selection; (3) transaction credentials; and (4) an approval of the transaction. The transaction can proceed to further processing steps (e.g., payment) if these four types of information are present. The four types of information of the transaction is only used for ease of description.

In one arrangement, the transaction may include an optional type of information of criteria relating to the transaction. The criteria may include, inter alia, conditions (e.g., end of the month) to be satisfied before payment of the completed transaction is made, payment once goods and/or services are delivered, cash on delivery, and the like. The criteria enable the user to approve a transaction but delay completing the transaction until after the criteria are met. For example, a user may order food, set a criterion to be cash on delivery, and approve the transaction. The approved transaction enables the restaurant to start preparing the food. However, the transaction is only completed when the user receives the food in accordance with the criterion.

The unique transaction name is defined by the user. For example, the user may define the unique transaction name to be “coffee order”, “grocery order”, “shoes order”, and the like. When defining a unique transaction name, a request is sent to transaction processing server 110 to determine whether the unique transaction name is used on a postponed transaction associated with the user account. If a unique transaction name is not defined by the user, an identifier of the transaction can be set as the unique transaction name. The unique transaction name and the user account can then be used to continue a postponed transaction in sub-process 320 (see step 322 below).

The goods and/or services selection enables the user to add or remove goods and/or services from the transaction. The step of adding and removing goods and/or services from the transaction is not described for simplicity sake.

The transaction also requires transaction credentials to be provided. In one arrangement, the user account, with which the transaction is associated, includes transaction credentials. The transaction credentials of the user account can be added into the transaction.

In one arrangement, adding the transaction credentials of the user account into the transaction requires an approval from the user. In another arrangement, the transaction credentials of the user account are defined in the user account as the default transaction credentials and are to be used for a transaction associated with the user account.

In another arrangement, the user may enter the transaction credentials at the device 102, 103, 104 if the user account does not include any transaction credentials or if the user does not want to use the transaction credentials in the user account.

In one arrangement, the user may set criteria relating to the transaction as described above.

The approval of the transaction may be in the form of a submit button displayed on the display of the device 102, 103, 104. The button for approval of the transaction is deactivated if the remaining three types information are incomplete. The approval button is enabled to be selected by a user once the remaining three types of information are complete. Once all four types of information (and the criteria, if required) are entered in the transaction, the transaction may proceed to further processing steps (e.g., payment) and the method 200 can proceed from step 214 to step 216.

During step 214, the transaction may be interrupted to postpone the transaction. The postponement of a transaction may be performed by a first device 102, 103, or 104 that initiated the transaction. Alternatively, the postponement of the transaction may be performed by the transaction processing server 110.

In one arrangement, the postponement of the transaction may be triggered by the device 102, 103, 104. For example, a request to postpone the transaction occurs when the user has been idle (i.e., the transaction has been inactive) for a period of time and the device 102, 103, 104 sends the postponement request. For example, the device 102, 103, 104 has a timer that is reset whenever a user input is detected. If the timer reaches a predetermined amount of time (e.g., 5 minutes), then the device 102, 103, 104 sends a request to postpone the transaction. In another example, a request to postpone the transaction is sent to the transaction processing server 110 when the user closes the app or window that is being used to perform the transaction. In another example, a request to postpone the transaction is sent when the user presses a button called “postpone transaction” on the app or window to postpone the transaction. In another example, a request to postpone the transaction is generated when a user is near a retail outlet from which the user is ordering. For example, the merchant server 116 sets a radius on a retail outlet associated with the merchant. If the location of a device 103, 104 (which may be obtained via GPS of the device) is determined to be within the radius of the retail outlet, then the device automatically sends a request to postpone the transaction.

The request to postpone a transaction includes an identifier of the transaction and the user account associated with the transaction. The device 102, 103, 104 performing the method 200 sends the request to postpone the transaction to a transaction processing server 110.

In another arrangement, the postponement of the transaction may be triggered by the transaction processing server 110. In one example, the transaction processing server 110 determines that the transaction has not been updated for a period of time (i.e., the transaction has been inactive for a period of time) and postpones the transaction. In this arrangement, the device 102, 103, 104 sends any update to the transaction to the transaction processing server 110. However, if the transaction has no update, then the device 102, 103, 104 does not send any update, which in turn triggers the transaction processing server 110 to postpone the transaction because no update is received after the period of time.

In one arrangement, details of the transaction are periodically sent and saved on the transaction processing server 110 to prevent the loss of transaction details in the case of a failure on the device 102, 103, 104.

When an interrupt occurs, the method 200 proceeds from step 214 to sub-process 250, which postpones the transaction. Sub-process 250 is described below in relation to FIG. 5. A postponed transaction can be continued by another device 102, 103, 104 using the method 300 described below.

If no interrupt to postpone the transaction occurs, then the user can enter all the details in the four types of information (e.g., other goods and/or services to purchase, transaction credentials, etc.) (and also the criteria, if required) required to complete the transaction.

The method 200 then proceeds from step 214 to step 216.

In step 216, the transaction is approved as all four types of information discussed above are received. The device 102, 103, or 104 then forwards the completed transaction to the transaction processing server 110. The method 200 then proceeds from step 216 to step 218.

In step 218, the transaction processing server 110 determines whether there are criteria relating to the approved transaction. The criteria are as discussed above. If there are criteria relating to the approved transaction (YES), the method 200 proceeds from step 218 to sub-process 250. Otherwise (NO), the method 200 proceeds from step 218 to step 220.

In step 220, the transaction processing server 110 generates a transaction request message based on a completed transaction. The transaction processing server 110 deems the approved transaction to be completed as there is no criterion pending on the transaction. The transaction processing server 110 then generates a transaction request message based on the completed transaction. The transaction processing server 110 may communicate with the token server 112 to tokenize the transaction request message.

To facilitate a transfer of funds from the user's payment account to the merchant's payment account, the transaction processing server 110 then forwards the transaction request message to the acquirer server 113, which in turn forwards the transaction request message to the payment network server 114. The payment network server 114 then forwards the transaction request message to the issuer server 115 and receives an authorization response (i.e., approval or denial) of the transaction request message.

When the transaction processing server 110 receives a completed transaction, the transaction processing server 110 also disassociates the devices 102, 103, which have been temporarily paired with the user account, from the user account. Therefore, the devices 102, 103 need to be paired with the user account again before the devices 102, 103 can again use the user account as described in the method 200.

The method 200 then concludes at the conclusion of step 220.

### Continuing a Postponed Transaction

FIG. 3 relates to a method 300 for continuing a postponed transaction. The method 300 enables a second device (i.e., devices 102, 103, or 104) to continue with a transaction that has been postponed. The transaction can then be further postponed or completed.

If the request to continue a postponed transaction is from a non-trusted device 102 or 103, the non-trusted device 102 or 103 is temporarily paired with the user account (see steps 324, 226, and 228 of sub-process 320). Once the transaction is further postponed or completed, the non-trusted device 102 or 103 is unpaired or disassociated from the user account at the respective step 258 (see FIG. 5) or step 318 (see below).

The method 300 commences at step 310 by receiving, at a device 102, 103, or 104, a request to continue with a postponed transaction.

In one arrangement, a user logs into a user account at the device 102, 103, or 104 and selects a postponed transaction. The user then selects a “continue transaction” button to continue with a postponed transaction.

In another arrangement, a user selects an item to be purchased at the device 102, 103, 104 and requests that the item be added into a postponed. The user also identifies a user account associated with the postponed.

For example, the user uses the user device 104 (which may be a smart speaker) to complete a postponed transaction. For example, the user may use the unique transaction name when requesting the smart speaker to continue with the postponed transaction. For example, the user may utter the sentence: “Hi (Smart Speaker), let me complete my coffee order” or “Hi (Smart Speaker), let me complete my grocery order”. The “coffee order” and “grocery order” being the unique transaction name of the postponed transaction. In this example, the smart speaker is associated with one user account. The smart speaker then transmits a request to the transaction processing server 110 to continue with the postponed transaction. The smart speaker also transmits the user account associated with the smart speaker when sending the request. If there are multiple user accounts associated with the smart speaker, the smart speaker requests the user to select a user account to use and sends the selected user account along with the request.

Therefore, in step 310, the unique transaction name of a postponed transaction and the user account associated with the postponed transaction are sent to the transaction processing server 110. The unique transaction name and the user account are required to identify whether a transaction is related to a postponed transaction.

The method 300 then proceeds from step 310 to sub-process 320.

Sub-process 320 determines whether a device used to perform the request in step 310 is associated with the user account that is associated with a trusted device that initiated the transaction. In other words, sub-process 320 determines whether a device used to perform the request in step 310 is a trusted device of the user account submitted in step 310. Sub-process 320 is described below in relation to FIG. 4B.

If the user device 104 is used to initiate the request of step 310, sub-process 320 returns the details of the postponed transaction selected in step 310.

If the transaction device 103 or the merchant device 102 is used to initiate the request of step 310, sub-process 320 performs an authorization to temporarily pair the transaction device 103 or the merchant device 102 with the user account entered in step 310. Such an authorization is performed by a trusted device 104 and is described in detail below in relation to FIG. 4B. Once paired, sub-process 320 returns the details of the postponed transaction.

The transaction device 103 or the merchant device 102 is unpaired or disassociated from the user account when the transaction is further postponed (see step 258 in FIG. 5) or completed (see step 318 in FIG. 3).

The method 300 then proceeds from sub-process 320 to step 315.

In step 315, the device 102, 103, or 104 receives the details of the postponed transaction selected in step 310. The details include the completion status of each of the four types of information of the transaction. For example, if there is no goods selected in the postponed transaction, then details indicate that the goods selection part is not completed yet. In another example, if the transaction credentials are already filled in the postponed transaction, then the details indicate that the transaction credentials part is already completed. The details also include any criteria relating to the transaction. The method 300 proceeds from step 315 to step 316.

In step 316, the device 102, 103, or 104 receives information relating to the postponed transaction. The information can be transaction credentials, other goods and/or services to be purchased, delivery address, and the like. Step 316 performs similar operations as described in step 214 above. The user can also modify any of the described four types of information of the transaction. The user can also modify the criteria of the transaction. As described above, the four types of information of the transaction is only used for ease of description.

In one arrangement, the modification of the transaction details require a user to select a “modify transaction” button before modifying any details of the transaction. If any of the information is amended, then approval of the transaction is removed. The user should then approve the transaction again after making modifications to the transaction.

During step 316, the user may interrupt the purchase to postpone the transaction. The interrupt to postpone the transaction is similar to the interrupt described in step 214 above. As described above, the interrupt to postpone the transaction can be performed by either the device 102, 103, 104 or the transaction processing server 110. When an interrupt occurs, the method 300 proceeds from step 316 to sub-process 250, which postpones the transaction. Sub-process 250 is described below in relation to FIG. 5. A postponed transaction can be continued by another device 102, 103, 104 using the method 300.

If no interrupt to postpone the transaction occurs, then the user enters all the details required to complete the transaction, as described in step 214 above.

The method 300 then proceeds from step 316 to step 318.

In step 318, the transaction is approved if all four types of information discussed above are received. Step 318 performs similar operations described in step 216 above. The device 102, 103, or 104 then forwards the approved transaction to the transaction processing server 110. The method 300 then proceeds from step 318 to step 320.

In step 320, the transaction processing server 110 determines whether there are criteria relating to the approved transaction. The criteria are as discussed above. If there are criteria relating to the approved transaction (YES), the method 300 proceeds from step 320 to sub-process 250. Otherwise (NO), the method 300 proceeds from step 320 to step 322.

In step 322, the transaction processing server 110 generates a transaction request message based on the completed transaction. The transaction processing server 110 deems the approved transaction to be completed as there is no criterion pending on the transaction. The transaction processing server 110 then generates a transaction request message based on the completed transaction. The transaction processing server 110 may communicate with the token server 112 to tokenize the transaction request message.

To facilitate a transfer of funds from the user's payment account to the merchant's payment account, the transaction processing server 110 then forwards the transaction request message to the acquirer server 113, which in turn forwards the transaction request message to the payment network server 114. The payment network server 114 then forwards the transaction request message to the issuer server 115 and receives an authorization response (i.e., approval or denial) of the transaction request message.

When the transaction processing server 110 receives a completed transaction, the transaction processing server 110 also disassociates the devices 102, 103, which have been paired with the user account, from the user account. Therefore, the devices 102, 103 need to be paired with the user account again before the devices 102, 103 can again use the user account as described in the method 300.

The method 300 then concludes at the conclusion of step 318.

### Sub-Process 220

FIG. 4A shows a flow diagram of sub-process 220 to determine whether a first device 102, 103, or 104 used in initiating a transaction is associated with a user account. The steps of sub-process 220 may be implemented as one or more software application programs 1333 executable within the computer system 1300, on which the transaction processing server 110 can be implemented.

Sub-process 220 commences at step 222 by receiving, at the transaction processing server 110, a request from the device 102, 103, or 104 to use a user account to process a transaction (entered at step 210). Sub-process 220 proceeds from step 222 to step 224.

In step 224, the transaction processing server 110 determines whether the device 102, 103, 104, from which the request in step 222 is received, is associated with the user account. In other words, step 224 determines whether the device 102, 103, 104 is a trusted device. As discussed above, a trusted device is a user device 104 that is registered on the user account. Therefore, the user device 104 is a trusted device, while the device 102 or 103 is not a trusted device. In one arrangement, the transaction processing server 110 may perform this determination by comparing the unique identifier of the device 102, 103, 104 (from which the request in step 22 is received) with the unique identifiers of the trusted devices 104 associated with the user account.

If the user account is stored in a user token (see the on-boarding section above), then the transaction processing server 110 communicates with the token server 112 to detokenize the user token to obtain details (e.g., the list of trusted devices, the payment accounts associated with the user account, etc.) of the user account.

As described above, trusted devices 104 are approved to process a transaction using a user account, with which the trusted devices 104 are associated. That is, a trusted device 104 is a device that is associated with a user account. On the other hand, non-trusted devices 102, 103 require to be associated with the user account (at least temporarily) to enable the non-trusted devices 102, 103 to use the user account for entering details of the transaction. That is, the non-trusted devices 102, 103 are not associated with the user account.

If the unique identifier of the device 104 is associated with the user account (YES), sub-process 220 proceeds from step 224 to step 230. If the unique identifier of the device 102, 103 is not associated with the user account (NO), sub-process 220 proceeds from step 224 to step 226.

In step 226, the transaction processing server 110 transmits a pairing request to pair the device 102, 103 with the user account.

In one arrangement, the pairing request is transmitted to the device 102, 103, which in turn displays that an authorization to pair the device 102, 103 with the user account identified in step 222 is required. The device 102, 103 prompts a user to enter an authorization code that is unique to a trusted device 104. The user may log in to the user account to obtain an authorization code of the trusted device 104. The user then enters the authorization code. The authorization code may be in the form of a barcode, a QR code, and the like and may be scanned by the device 102, 103 from a display of the trusted device 104. The authorization code may also be manually entered into the device 102, 103 by the user.

In another arrangement, the pairing request is transmitted to the trusted devices 104 that are set in the user account for authorizing/approving such a pairing. The user in turn gets a notification from the trusted devices 104 to approve the pairing request. The user logs in to the user account and authorizes the pairing request.

In yet another arrangement, the pairing request is transmitted to the device 102, 103. The user logs in to the user account using one of the trusted devices 104 and enters an identifier unique to the transaction (to which the pairing request is related). The trusted device 104 then displays that there is a pending pairing request to authorize pairing the device 102, 103 with the user account. The user then authorizes the pairing request at the user device 104.

Once a non-trusted device 102, 103 is paired with the user account, the paired non-trusted device 102, 103 can perform steps 212 to 216 of the method 200. Further, the paired non-trusted device 102, 103 may use any transaction credentials listed in the user account to complete the transaction that the paired non-trusted device 102, 103 is processing.

Sub-process 220 proceeds from step 226 to step 228.

In step 228, the transaction processing server 110 receives the authorization of the pairing request. The authorization of the pairing request may be received from the device 102, 103 (from which the request in step 222 is received) or from a trusted user device 104, depending on the arrangement implemented (see step 226 above).

If an authorization of the pairing is not received by the transaction processing server 110, the transaction processing server 110 rejects associating the device 102, 103 with the user account. The transaction processing server 110 then informs the device 102, 103 that the request for using the user account for the transaction is rejected. This step is not shown for simplicity sake.

Sub-process 220 proceeds from step 228 to step 230.

In step 230, the transaction processing server 110 transmits a confirmation that the user account can be used for processing the transaction. Therefore, at the conclusion of step 230, sub-process 220 concludes and the purchase process proceeds to step 212 of the method 200.

### Sub-Process 320

FIG. 4B shows a flow diagram of sub-process 320 to determine whether a second device (e.g., device 102, 103, or 104), which is requesting to continue a postponed transaction, is associated with a user account that is associated with a device that initiated the transaction. The steps of sub-process 320 may be implemented as one or more software application programs 1333 executable within the computer system 1300, on which the transaction processing server 110 can be implemented.

Sub-process 320 commences at step 322 by receiving, at the transaction processing server 110, a request from the device 102, 103, or 104 to continue with a transaction that has been postponed. The request includes the unique transaction name of a postponed transaction and the user account associated with the postponed transaction.

In one arrangement, the postponed transactions and/or the user account are tokenized by the token server 112. Therefore, the transaction processing server 110 communicates with the token server 112 to detokenize the postponed transactions and/or the user account before proceeding to step 324.

Sub-process 320 proceeds from step 322 to step 324.

In step 324, the transaction processing server 110 determines whether the device 102, 103, 104, from which the request in step 322 is received, is associated with the user account, with which the device initiating the transaction is associated. In other words, the transaction processing server 110 determines whether the device 102, 103, 104 is a trusted device. As discussed above, a trusted device is a user device 104 that is registered on the user account.

Therefore, the user device 104 is a trusted device, while the device 102 or 103 is not a trusted device. In one arrangement, the transaction processing server 110 may perform this determination by comparing the unique identifier of the device 102, 103, 104 (from which the request in step 22 is received) with the unique identifiers of the trusted devices 104 associated with the user account.

If the user account is stored in a user token (see the on-boarding section above), then the transaction processing server 110 communicates with the token server 112 to detokenize the user token to obtain details (e.g., the list of trusted devices, the payment accounts associated with the user account, etc.) of the user account.

If the unique identifier of the device 104 is associated with the user account (YES), sub-process 320 proceeds from step 324 to step 326. If the unique identifier of the device 102, 103 is not associated with the user account (NO), sub-process 320 proceeds from step 324 to step 226.

In step 226, the transaction processing server 110 transmits a pairing request to pair the device 102, 103 with the user account. This step is the same step performed in sub-process 220.

Sub-process 320 proceeds from step 226 to step 228.

In step 228, the transaction processing server 110 receives the authorization of the pairing request. The authorization of the pairing request may be received from the device 102, 103 (from which the request in step 322 is received) or from a trusted user device 104, depending on the arrangement implemented (see step 226 above).

Once a non-trusted device 102, 103 is paired with the user account, the paired non-trusted device 102, 103 can perform steps 212 to 216 of the method 200. Further, the paired non-trusted device 102, 103 may use any transaction credentials listed in the user account to complete the transaction that the paired non-trusted device 102, 103 is processing.

Sub-process 320 proceeds from step 228 to step 326.

In step 326, the transaction processing server 110 retrieves details of the postponed transaction in response to the determination of step 324. The details may be retrieved from the storage devices 1309 of the computing device 1300, on which the transaction processing server 110 is implemented. As described in the method 300 above, the details include the completion status of the different types of information of the postponed transaction. Sub-process 320 proceeds from step 326 to step 328.

In step 328, the transaction processing server 110 transmits the details (retrieved in step 326) to the device 102, 103, 104 (from which the request of step 322 is received). At the conclusion of step 328, sub-process 320 concludes and the purchase process proceeds to step 315 of the method 300.

### Sub-Process 250—Postponement of a Transaction

FIG. 5 shows a flow diagram of sub-process 250 to postpone a transaction. The steps of sub-process 250 may be implemented as one or more software application programs 1333 executable within the computer system 1300, on which the transaction processing server 110 can be implemented.

Sub-process 250 commences at step 252 by determining, at the transaction processing server 110, whether to postpone a transaction. As described above in relation to steps 214 and 316 above, there are many arrangements for postponing a transaction.

In one arrangement, the postponement of the transaction may be triggered by the device 102, 103, 104. In this arrangement, the transaction processing server determines to postpone a transaction (YES) when receiving a postponement request from the device 102, 103, 104.

In another arrangement, the postponement of the transaction may be triggered by the transaction processing server 110. As described above, the transaction processing server 110 may determine that the transaction has not been updated for a period of time and postpone the transaction. For example, the transaction processing server 110 has a timer that is reset whenever an update to the transaction is received from the device 102, 103, 104. If the timer reaches a predetermined amount of time (e.g., 5 minutes), then the transaction processing server 110 determines that the transaction is to be postponed (YES).

In another arrangement, COD

If the transaction processing server 110 determines that the transaction is to be postponed (YES), sub-process 250 proceeds from step 252 to step 254. If the transaction processing server 110 determines that the transaction is not to be postponed (NO), sub-process 250 remains at step 252.

In step 254, the transaction processing server 110 stores the details relating to the postponed transaction. The details relate to any transaction details (e.g., items and/or services to be purchased, entered transaction credentials, user information, etc.) of the transaction to be postponed. The details also include indications of the completion status of each type of information of the transaction. The details may be stored at the storage devices 1309 of the computing device 1300, on which the transaction processing server 110 is implemented.

The identifier of the postponed transaction is also associated with the user account (which is associated with the postponed transaction). The stored identifier of the postponed transaction can be managed by the user through the user account. For example, the user may modify or delete any postponed transaction listed in the user account.

In one arrangement, the transaction processing server 110 communicates with the token server 112 to tokenize the stored details and/or identifier of the postponed transaction.

Sub-process 250 proceeds from step 254 to step 255.

In step 255, the transaction processing server 110 determines whether the postponed transaction is approved. In one example, the transaction is determined to be approved when the transaction has all four types of information described above. If the transaction is determined to be approved (YES), then sub-process 250 proceeds from step 255 to step 257. Otherwise (NO), sub-process 250 proceeds from step 255 to step 256.

In step 257, the transaction processing server 110 transmits the approved transaction to the merchant. For example, the approved transaction relates to a food order and has a criterion of cash on delivery. The approved transaction is sent to the restaurant (i.e., the merchant) to enable the restaurant to start preparing the food.

Step 218 of the method 200 or step 320 of the method 300, in conjunction with sub-process 250 and criteria of the transaction, enable the user to approve a transaction and a merchant to receive the approved transaction. The combination of these steps, sub-process 250, and the criteria also enables the user to modify an approved transaction that is being postponed. Sub-process 250 proceeds from step 257 to step 256.

In step 256, the transaction processing server 110 determines whether to disassociate a device processing the transaction using the user account. If the device processing the transaction (either during the method 200 or 300) is one of the trusted devices 104, then the transaction processing server 110 determines that the device is not to be disassociated from the user account (NO). Sub-process 250 proceeds from step 256 to step 260.

However, If the device processing the transaction (either during the method 200 or 300) is one of the non-trusted devices 102, 103 (which has been paired either during sub-process 220 or 320), then the transaction processing server 110 determines that the device is to be disassociated from the user account (YES). Sub-process 250 proceeds from step 256 to step 258.

In step 258, the transaction processing server 110 disassociates the paired device 102, 103 from the user account. Therefore, at the end of step 258, the user account is associated with the devices 104, but the user account is no longer associated with any of devices 102, 103 that is paired during sub-process 220 or 320. Sub-process 250 proceeds from step 258 to step 260.

In step 260, the transaction processing server 110 transmits a confirmation that the transaction has been postponed to the device 102, 103, 104. When the device 102, 103, 104 receives the confirmation response, the device 102, 103, 104 displays the confirmation response on a display to inform the user of the postponement of the transaction. Other details (e.g., the unique transaction name and the user account) of the postponed transaction may also be displayed to allow the user to continue the postponed transaction at a later time. A display informing the user that the paired device 102, 103 has been disassociated from the user account may also be displayed on the device 102, 103.

Sub-process 250 concludes at the conclusion of step 256.

### Use Case Examples

Some examples of use case of the system 100 will now be described. These examples are illustrative and not restrictive.

### First Use Case of the System 100

In the first use case, Joe Bloke is a registered user of the transaction processing server 110 and has a user account which has a unique name of “Joe Bloke Sydney”. Joe is mindful about cyber security and therefore does not list any transaction credentials in the user account. Therefore, the transaction credentials have to be entered when performing a transaction.

The user account “Joe Bloke Sydney” also lists trusted devices 104 that can be used to perform transactions. One of the trusted devices is a smart speaker in Joe's house. Joe has also set his smart mobile phone as a trusted device 104 that can authorize a pairing request between a non-trusted device (e.g., devices 102, 103) and the “Joe Bloke Sydney” user account.

A merchant called Best Deals has a store in New York and stores its item inventory in the merchant server 116. The Best Deals store has merchant devices 102.

In this use case, Joe goes to New York for holiday and visits the Best Deals store. Joe likes a suit in the store and brings the suit to one of the merchant devices 102. The merchant device 102 scans a tag of the suit and initiates a transaction (step 210). Once the transaction is initiated, the merchant device 102 requests Joe to enter a user account to use for the transaction. Joe enters the Joe Bloke Sydney user account.

The merchant device 102 then sends the request to use the Joe Bloke Sydney user account for the transaction to the transaction processing server 110 (sub-process 220 and step 222). The transaction processing server 110 determines (step 224) that the device 102 is not associated with the Joe Bloke Sydney user account (i.e., the device 102 is not a trusted device) and transmits (step 226) a pairing request to pair the merchant device 102 with the Joe Bloke Sydney user account.

In one arrangement, the pairing request is transmitted to the merchant device 102, which in turn displays that an authorization to pair the merchant device 102 with the Joe Bloke Sydney user account is required. The merchant device 102 then prompts Joe to enter an authorization code that is unique to a trusted device 104, which in this case is Joe's smart mobile phone. Joe can log in to the Joe Bloke Sydney user account to obtain an authorization code associated with his smart mobile phone. The authorization code may be in the form of a barcode, a QR code, and the like and may be scanned by the merchant device 102 from a display of Joe's smart mobile phone. The authorization code may also be manually entered into the merchant device 102 by Joe.

In another arrangement, the pairing request is transmitted to the trusted devices 104 that are set in the Joe Bloke Sydney user account for authorizing/approving such a pairing, which in this case is Joe's smart mobile phone. Joe in turn gets a notification from his smart mobile phone to approve the pairing request. Joe logs in to the user account and authorizes the pairing request.

In yet another arrangement, the pairing request is transmitted to the merchant device 102. Joe logs in to the Joe Bloke Sydney user account on his smart mobile phone and enters an identifier unique to the transaction (to which the pairing request is related). Joe's smart mobile phone then displays that there is a pending pairing request to authorize pairing the merchant device 102 with the Joe Bloke Sydney user account. Joe then authorizes the pairing request using his smart mobile phone.

The transaction processing server 110 then associates the transaction with the user account. The transaction processing server 110 then transmits a confirmation that the transaction is associated with the Joe Bloke Sydney user account (step 230).

The merchant device 102 receives the confirmation (step 212) and the suit that is scanned to initiate the transaction is added to the transaction (step 214). Joe can also name the transaction (i.e., the unique transaction name) as New York Suit in case the transaction is postponed. If Joe does not set a unique transaction name, then an identifier (e.g., a list of number) of the transaction is set as the unique transaction name. The first type of information of the transaction is therefore completed.

Joe does not want to buy anything else so the second type of information of the transaction is completed.

When Joe wants to enter the payment details for the transaction, he realizes that he left the credit card (i.e., the transaction credentials) that he would like to use for the transaction in Sydney. Accordingly, he postpones the transaction by pressing a “Postpone Transaction” button on the merchant device 102. Therefore, the third and fourth types of information of the transaction are not completed.

Accordingly, the transaction processing server 110 receives the request to postpone the transaction. The transaction processing server 110 then determines to postpone the transaction based on the request (step 252 of sub-process 250) and stores the details of the postponed transaction (step 254). Certain details (e.g., the unique transaction name) of the postponed transaction is also stored in the Joe Bloke Sydney user account. The completion status of the different types of information of the transaction are also stored.

The transaction processing server 110 then determines (step 256) whether to disassociate the device 102 from the Joe Bloke Sydney user account. As the device 102 is not listed as one of the trusted devices 104, the transaction processing server 110 disassociates the device 102 from the Joe Bloke Sydney user account (step 258).

The transaction processing server 110 then transmits a response confirming postponement of the transaction to the device 102 (step 260). The device 102 may display a confirmation that the transaction with the unique transaction name of New York Suit has been postponed and that the postponed transaction is associated with the Joe Bloke Sydney user account.

When Joe returns to Sydney, he uses a smart speaker (which is listed as a trusted device in the Joe Bloke Sydney user account) to complete the postponed transaction (step 310). Joe says “Hi Smart Speaker, I would like to complete my New York Suit purchase using my Joe Bloke Sydney user account.” Based on the unique transaction name and the user account, the smart speaker then sends a request to continue the postponed transaction with the name of New York Suit, which is associated with the Joe Bloke Sydney user account. The transaction processing server 110 receives the request to continue with the postponed transaction (sub-process 320 and step 322).

As discussed above, step 324 of sub-process 320 determines whether the Smart Speaker is associated with the Joe Bloke Sydney user account (which was associated with the device 102 when the transaction was initiated). In this case, the Smart Speaker is associated with the Joe Bloke Sydney user account and the transaction processing server 110 retrieves (step 326) the details of the postponed transaction using the unique transaction name is “New York Suit” and the user account “Joe Bloke Sydney”.

The transaction processing server 110 in turn transmits (step 328) the details relating to the New York Suit transaction. The smart speaker in turn receives the details relating to the New York Suit transaction (step 315). Joe can then enter the third type of information (i.e., his credit card details (i.e., transaction credentials)) and the fourth type of information (i.e., the approval of the transaction) (see step 316) to approve the transaction. In step 316, Joe can also choose to have the suit delivered to a delivery address.

The approved transaction is then sent (step 318) to the transaction processing server 110. In this case, Joe did not set any criteria and accordingly the transaction processing server 110 deems the approved transaction to be a completed transaction. The transaction processing server 110 then generates a transaction request message based on the completed transaction. The transaction request message is then transmitted to the payment server 114 by the transaction processing server 110.

### Second Use Case of the System 100

The second use case relates to the first use case. In the second use case, Joe returns to the hotel in New York after postponing the New York Suit transaction. At the hotel, Joe meets his friend who happens to be looking at Best Deals website on a tablet (i.e., a transaction device 103) to purchase a jacket. However, Joe's friend cannot carry the jacket back to Sydney as his suitcase is full and is thinking of shipping the jacket back to Sydney. Joe then tells his friend that they can share the shipping costs by combining Joe's suit purchase with the friend's jacket purchase. The friend agrees.

The friend then uses his tablet (i.e., the transaction device 103) to request to continue the postponed transaction having a unique transaction name of New York Suit using the Joe Bloke Sydney user account. The Joe Bloke Sydney user account, in this example, may have other postponed transaction with unique transaction names of Sydney Suit, Wife's Dress Purchase, and the like. However, the transaction processing server 110 determines from the unique transaction name of New York Suit and the Joe Bloke Sydney user account which particular postponed transaction that the device 103 is requesting.

The tablet then sends the request to use the Joe Bloke Sydney user account to continue the New York Suit transaction to the transaction processing server 110 (sub-process 320 and step 322). The transaction processing server 110 determines (step 324) that the tablet is not associated with the Joe Bloke Sydney user account (i.e., the tablet is not a trusted device of the Joe Bloke Sydney user account) and transmits (step 226) a pairing request to pair the tablet with the Joe Bloke Sydney user account.

In one arrangement, the pairing request is transmitted to the tablet, which in turn displays that an authorization to pair the tablet with the Joe Bloke Sydney user account is required. The tablet then prompts Joe to enter an authorization code that is unique to a trusted device 104, which in this case is Joe's smart mobile phone. Joe can log in to the Joe Bloke Sydney user account to obtain an authorization code associated with his smart mobile phone.

The authorization code may be in the form of a barcode, a QR code, and the like and may be scanned by the tablet from a display of Joe's smart mobile phone. The authorization code may also be manually entered into the tablet by Joe.

In another arrangement, the pairing request is transmitted to the trusted devices 104 that are set in the Joe Bloke Sydney user account for authorizing/approving such a pairing, which in this case is Joe's smart mobile phone. Joe in turn gets a notification from his smart mobile phone to approve the pairing request. Joe logs in to the user account and authorizes the pairing request.

In yet another arrangement, the pairing request is transmitted to the tablet. Joe logs in to the Joe Bloke Sydney user account on his smart mobile phone and enters an identifier unique to the transaction (to which the pairing request is related). Joe's smart mobile phone then displays that there is a pending pairing request to authorize pairing the tablet with the Joe Bloke Sydney user account. Joe then authorizes the pairing request using his smart mobile phone.

The transaction processing server 110 then retrieves (step 326) and transmits (step 328) the details of the New York Suit transaction.

The tablet then receives a request to modify the second type of information (i.e., the goods selection) of the transaction. The friend then uses the tablet to access Big Deals' merchant server 116 to select the jacket that the friend would like to purchase. The friend adds the jacket in the second type of information of the New York Suit transaction (step 316) and postpones (sub-process 250) the New York Suit transaction.

The transaction processing server 110 then determines (step 256) whether to disassociate the device 103 from the Joe Bloke Sydney user account. As the device 103 is not listed as one of the trusted devices 104, the transaction processing server 110 disassociates the device 103 from the Joe Bloke Sydney user account (step 258).

The transaction processing server 110 then transmits a response confirming postponement of the transaction to the device 103 (step 260). The device 103 may display a confirmation that the transaction with the unique transaction name of New York Suit has been postponed and that the postponed transaction is associated with the Joe Bloke Sydney user account.

When Joe returns to Sydney, he completes the New York Suit transaction as described above in relation to the first use case.

### Third Use Case of the System 100

The third use case relates to the first use case. In the third use case, Joe wants to purchase some goods from a merchant. Joe uses his work computer (which is a device 103) to log into the Joe Bloke Sydney user account and to access a merchant server 116 of a merchant called Awesome Wines.

The merchant server 116 of Awesome Wines sends a list of goods that Joe can buy. The list is displayed on Joe's work computer. Joe reviews the list and sees a bottle of wine that he would like to buy. Joe presses a purchase button to purchase the bottle of wine. Such a selection of goods initiates a transaction (step 210). As the work computer is already logged into the Joe Bloke Sydney user account, the transaction processing server 110 determines whether the work computer is associated with the Joe Bloke Sydney user account (sub-process 220).

As the work computer is not associated with the Joe Bloke Sydney user account, the transaction processing server 110 proceeds with pairing the work computer with the Joe Bloke Sydney user account. The pairing process is as previously described.

Once paired, the transaction processing server 110 associates the transaction with the Joe Bloke Sydney user account (step 230). The transaction processing server 110 in turn transmits the confirmation of the association (step 230) to enable Joe to enter other details (e.g., unique transaction name, transaction credentials, etc.) of the transaction.

The bottle of wine selected by Joe is included in the transaction (step 214). However, before Joe could enter any other details, his boss walks into his office to discuss about work. So Joe closes the window displaying the transaction.

This triggers the work computer to send a request to postpone the transaction to the transaction processing server 110. The transaction processing server 110 determines at step 252 that the transaction is to be postponed based on this request. The transaction processing server 110 also stores (step 254) the details of the postponed transaction.

The transaction processing server 110 then determines (step 256) whether to disassociate the device 103 from the Joe Bloke Sydney user account. As the device 103 is not listed as one of the trusted devices 104, the transaction processing server 110 disassociates the device 103 from the Joe Bloke Sydney user account (step 258).

The transaction processing server 110 then transmits a response confirming postponement of the transaction to the device 103 (step 260). The device 103 may display a confirmation that the transaction with the unique transaction name of 123456789 has been postponed and that the postponed transaction is associated with the Joe Bloke Sydney user account. The unique transaction name is a number identifier as Joe has not entered a personalized unique transaction name.

When Joe returns home, he may continue the postponed transaction using the unique transaction name of 123456789 and the Joe Bloke Sydney user account. Joe can complete the transaction as described above in relation to the first use case.

### Fourth Use Case of the System 100

The fourth use case relates to the first use case. In the fourth use case, Joe wants to purchase some food from a merchant. Joe uses his work computer (which is a device 103) to log into the Joe Bloke Sydney user account and to access a merchant server 116 of a merchant called Best Chinese Restaurant.

The merchant server 116 of Best Chinese Restaurant sends a list of food that Joe can buy. The list is displayed on Joe's work computer. Joe reviews the list and sees some food that he would like to buy for dinner. Joe selects some food (e.g., spring rolls) and presses a purchase button to purchase the food. Such a selection of food initiates a transaction (step 210). As the work computer is already logged into the Joe Bloke Sydney user account, the transaction processing server 110 determines whether the work computer is associated with the Joe Bloke Sydney user account (sub-process 220).

As the work computer is not associated with the Joe Bloke Sydney user account, the transaction processing server 110 proceeds with pairing the work computer with the Joe Bloke Sydney user account. The pairing process is as previously described.

Once paired, the transaction processing server 110 associates the transaction with the Joe Bloke Sydney user account (step 230). The transaction processing server 110 in turn transmits the confirmation of the association (step 230) to enable Joe to enter other details (e.g., unique transaction name, transaction credentials, etc.) of the transaction.

The food selected by Joe is included in the transaction (step 214). Joe also sets a criterion of cash on delivery as Joe intends to pay for the food when he picks the food up from the restaurant. Joe sets the unique transaction name to Joe's Dinner. Joe then approves the transaction.

The work computer then sends the approved transaction to the transaction processing server 110, which in turn determines (step 218) whether there are criteria relating to the approved transaction. In this case, there is a criterion of cash on delivery and therefore the transaction processing server 110 postpones the transaction. During the postponement sub-process 250, the transaction processing server 110 determines (step 255) that the postponed transaction is an approved transaction and transmits (step 257) the approved transaction to the Best Chinese Restaurant. The restaurant can then start preparing the food.

On the way to the restaurant, Joe feels like having more spring rolls and uses his smartphone (i.e., a trusted device 104) to log into Joe Bloke Sydney user account and selects the postponed transaction with the unique identifier of Joe's Dinner. Depending on the arrangement implemented, the postponed transaction may be continued without further input from Joe or the postponed transaction may be continued after Joe presses the “continue transaction” button. As the smartphone is a trusted device 104, pairing is not required.

The transaction processing server 110 then retrieves (step 326) and transmits (step 328) the details of Joe's Dinner transaction. The smartphone in turn receives (step 315) details of the postponed transaction. Joe then modifies the transaction by selecting a “modify transaction” button and adding more spring rolls in the transaction and approves the transaction (step 316).

The approved transaction is then forwarded (step 318) to the transaction processing server 110, which in turn determines whether there are criteria relating to the approved transaction (step 320). In this case, the criterion of cash on delivery is unchanged and therefore the transaction processing server 110 postpones the transaction automatically without further input from Joe. Alternatively, the transaction processing server 110 may request Joe's confirmation that the transaction is to be postponed.

When Joe arrives at the restaurant, he receives the food and pays the restaurant. The payment can be performed by logging into the Joe Bloke Sydney account and accessing the Joe's Dinner transaction, removing the criterion (step 316), and approving (step 316) the transaction.

### Structural Context

### The Transaction Processing Server 110

FIGS. 6A and 6B depict a general-purpose computer system 1300, upon which the transaction processing server 110 described can be practiced.

As seen in FIG. 6A, the computer system 1300 includes a computer module 1301. An external Modulator-Demodulator (Modem) transceiver device 1316 may be used by the computer module 1301 for communicating to and from a communications network 1320 via a connection 1321. The communications network 1320 may be a wide-area network (VVAN), such as the Internet, a cellular telecommunications network, or a private WAN. Where the connection 1321 is a telephone line, the modem 1316 may be a traditional “dial-up” modem. Alternatively, where the connection 1321 is a high capacity (e.g., cable) connection, the modem 1316 may be a broadband modem. A wireless modem may also be used for wireless connection to the communications network 1320. The communications network 1320 can be used by the transaction processing server 110 to communicate with the devices 102, 103, 104 and the servers 112, 113, 116 in the system 100.

The computer module 1301 typically includes at least one processor unit 1305, and a memory unit 1306. For example, the memory unit 1306 may have semiconductor random access memory (RAM) and semiconductor read only memory (ROM). The computer module 1301 also includes an interface 1308 for the external modem 1316. In some implementations, the modem 1316 may be incorporated within the computer module 1301, for example within the interface 1308. The computer module 1301 also has a local network interface 1311, which permits coupling of the computer system 1300 via a connection 1323 to a local-area communications network 1322, known as a Local Area Network (LAN). As illustrated in FIG. 6A, the local communications network 1322 may also couple to the wide network 1320 via a connection 1324, which would typically include a so-called “firewall” device or device of similar functionality. The local network interface 1311 may comprise an Ethernet circuit card, a Bluetooth wireless arrangement or an IEEE 802.11 wireless arrangement; however, numerous other types of interfaces may be practiced for the interface 1311.

The I/O interfaces 1308 may afford either or both of serial and parallel connectivity, the former typically being implemented according to the Universal Serial Bus (USB) standards and having corresponding USB connectors (not illustrated). Storage devices 1309 are provided and typically include a hard disk drive (HDD) 1310. Other storage devices such as a floppy disk drive and a magnetic tape drive (not illustrated) may also be used. An optical disk drive 1312 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1300.

The components 1305 to 1312 of the computer module 1301 typically communicate via an interconnected bus 1304 and in a manner that results in a conventional mode of operation of the computer system 1300 known to those in the relevant art. For example, the processor 1305 is coupled to the system bus 1304 using a connection 1318. Likewise, the memory 1306 and optical disk drive 1312 are coupled to the system bus 1304 by connections 1319. Examples of computers on which the described arrangements can be practised include IBM-PC's and compatibles, Sun Sparcstations, Apple Mac™ or like computer systems.

The steps of sub-processes 220, 320, and 250 in FIGS. 4A, 4B, and 5, respectively, performed by the transaction processing server 110 may be implemented using the computer system 1300. The steps of sub-processes 220, 320, and 250 may be implemented as one or more software application programs 1333 executable within the computer system 1300. In particular, the steps of the sub-processes 220, 320, and 250 as performed by the transaction processing server 110 are effected by instructions 1331 (see FIG. 6B) in the software 1333 that are carried out within the computer system 1300. The software instructions 1331 may be formed as one or more code modules, each for performing one or more particular tasks. The software may also be divided into two separate parts, in which a first part and the corresponding code modules performs the steps of the transaction processing server 110 and a second part and the corresponding code modules manage the API and corresponding user interfaces in the merchant device 102, the user devices 104, the transaction device 103. In other words, the second part of the software manages the interaction between (a) the first part and (b) any one of the merchant device 102, the user devices 104, and the transaction device 103.

The software may be stored in a computer readable medium, including the storage devices described below, for example. The software is loaded into the computer system 1300 from the computer readable medium, and then executed by the computer system 1300. A computer readable medium having such software or computer program recorded on the computer readable medium is a computer program product. The use of the computer program product in the computer system 1300 preferably effects an advantageous apparatus for a transaction processing server 110.

The software 1333 is typically stored in the HDD 1310 or the memory 1306. The software is loaded into the computer system 1300 from a computer readable medium, and executed by the computer system 1300. Thus, for example, the software 1333 may be stored on an optically readable disk storage medium (e.g., CD-ROM) 1325 that is read by the optical disk drive 1312. A computer readable medium having such software or computer program recorded on it is a computer program product. The use of the computer program product in the computer system 1300 preferably effects an apparatus for a transaction processing server 110.

In some instances, the application programs 1333 may be supplied to the user encoded on one or more CD-ROMs 1325 and read via the corresponding drive 1312, or alternatively may be read by the user from the networks 1320 or 1322. Still further, the software can also be loaded into the computer system 1300 from other computer readable media. Computer readable storage media refers to any non-transitory tangible storage medium that provides recorded instructions and/or data to the computer system 1300 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1301. Examples of transitory or non-tangible computer readable transmission media that may also participate in the provision of software, application programs, instructions and/or data to the computer module 1301 include radio or infra-red transmission channels as well as a network connection to another computer or networked device, and the Internet or Intranets including e-mail transmissions and information recorded on Websites and the like.

The second part of the application programs 1333 and the corresponding code modules mentioned above may be executed to implement one or more API of the transaction processing server 110 with associated graphical user interfaces (GUIs) to be rendered or otherwise represented upon the display of the merchant device 102, the user devices 104, and the transaction device 103. Through manipulation of typically a keyboard and a mouse, a user of the merchant device 102, the user devices 104, and the transaction device 103 and the application may manipulate the interface presented on the display of the merchant device 102, the user devices 104, and the transaction device 103 in a functionally adaptable manner to provide controlling commands and/or input to the applications associated with the GUI(s). Other forms of functionally adaptable user interfaces may also be implemented, such as an audio interface utilizing speech prompts output via loudspeakers and user voice commands input via a microphone.

FIG. 6B is a detailed schematic block diagram of the processor 1305 and a “memory” 1334. The memory 1334 represents a logical aggregation of all the memory modules (including the HDD 1309 and semiconductor memory 1306) that can be accessed by the computer module 1301 in FIG. 6A.

When the computer module 1301 is initially powered up, a power-on self-test (POST) program 1350 executes. The POST program 1350 is typically stored in a ROM 1349 of the semiconductor memory 1306 of FIG. 6A. A hardware device such as the ROM 1349 storing software is sometimes referred to as firmware. The POST program 1350 examines hardware within the computer module 1301 to ensure proper functioning and typically checks the processor 1305, the memory 1334 (1309, 1306), and a basic input-output systems software (BIOS) module 1351, also typically stored in the ROM 1349, for correct operation. Once the POST program 1350 has run successfully, the BIOS 1351 activates the hard disk drive 1310 of FIG. 6A. Activation of the hard disk drive 1310 causes a bootstrap loader program 1352 that is resident on the hard disk drive 1310 to execute via the processor 1305. This loads an operating system 1353 into the RAM memory 1306, upon which the operating system 1353 commences operation. The operating system 1353 is a system level application, executable by the processor 1305, to fulfil various high level functions, including processor management, memory management, device management, storage management, software application interface, and generic user interface.

The operating system 1353 manages the memory 1334 (1309, 1306) to ensure that each process or application running on the computer module 1301 has sufficient memory in which to execute without colliding with memory allocated to another process. Furthermore, the different types of memory available in the system 1300 of FIG. 6A must be used properly so that each process can run effectively. Accordingly, the aggregated memory 1334 is not intended to illustrate how particular segments of memory are allocated (unless otherwise stated), but rather to provide a general view of the memory accessible by the computer system 1300 and how such is used.

As shown in FIG. 6B, the processor 1305 includes a number of functional modules including a control unit 1339, an arithmetic logic unit (ALU) 1340, and a local or internal memory 1348, sometimes called a cache memory. The cache memory 1348 typically includes a number of storage registers 1344-1346 in a register section. One or more internal busses 1341 functionally interconnect these functional modules. The processor 1305 typically also has one or more interfaces 1342 for communicating with external devices via the system bus 1304, using a connection 1318. The memory 1334 is coupled to the bus 1304 using a connection 1319.

The application program 1333 includes a sequence of instructions 1331 that may include conditional branch and loop instructions. The program 1333 may also include data 1332 which is used in execution of the program 1333. The instructions 1331 and the data 1332 are stored in memory locations 1328, 1329, 1330 and 1335, 1336, 1337, respectively. Depending upon the relative size of the instructions 1331 and the memory locations 1328-1330, a particular instruction may be stored in a single memory location as depicted by the instruction shown in the memory location 1330. Alternately, an instruction may be segmented into a number of parts each of which is stored in a separate memory location, as depicted by the instruction segments shown in the memory locations 1328 and 1329.

In general, the processor 1305 is given a set of instructions which are executed therein. The processor 1305 waits for a subsequent input, to which the processor 1305 reacts to by executing another set of instructions. Each input may be provided from one or more of a number of sources, including data generated by one or more of the input devices 1302, 1303, data received from an external source across one of the networks 1320, 1302, data retrieved from one of the storage devices 1306, 1309 or data retrieved from a storage medium 1325 (e.g., the database 109) inserted into the corresponding reader 1312, all depicted in FIG. 6A. The execution of a set of the instructions may in some cases result in output of data. Execution may also involve storing data or variables to the memory 1334.

The disclosed transaction processing server 110 arrangements use input variables 1354, which are stored in the memory 1334 in corresponding memory locations 1355, 1356, 1357. The payment network server 108 arrangements produce output variables 1361, which are stored in the memory 1334 in corresponding memory locations 1362, 1363, 1364. Intermediate variables 1358 may be stored in memory locations 1359, 1360, 1366 and 1367.

Referring to the processor 1305 of FIG. 6B, the registers 1344, 1345, 1346, the arithmetic logic unit (ALU) 1340, and the control unit 1339 work together to perform sequences of micro-operations needed to perform “fetch, decode, and execute” cycles for every instruction in the instruction set making up the program 1333. Each fetch, decode, and execute cycle comprises:

a fetch operation, which fetches or reads an instruction 1331 from a memory location 1328, 1329, 1330;
a decode operation in which the control unit 1339 determines which instruction has been fetched; and
an execute operation in which the control unit 1339 and/or the ALU 1340 execute the instruction.

Thereafter, a further fetch, decode, and execute cycle for the next instruction may be executed. Similarly, a store cycle may be performed by which the control unit 1339 stores or writes a value to a memory location 1332.

Each step of sub-processes 220, 320, and 250, as performed by the transaction processing server 110, is associated with one or more segments of the program 1333 and is performed by the register section 1344, 1345, 1347, the ALU 1340, and the control unit 1339 in the processor 1305 working together to perform the fetch, decode, and execute cycles for every instruction in the instruction set for the noted segments of the program 1333.

It is to be understood that the structural context of the computer system 1300 (i.e., the transaction processing server 110) is presented merely by way of example. Therefore, in some arrangements, one or more features of the server 1300 may be omitted. Also, in some arrangements, one or more features of the server 1300 may be combined together. Additionally, in some arrangements, one or more features of the server 1300 may be split into one or more component parts.

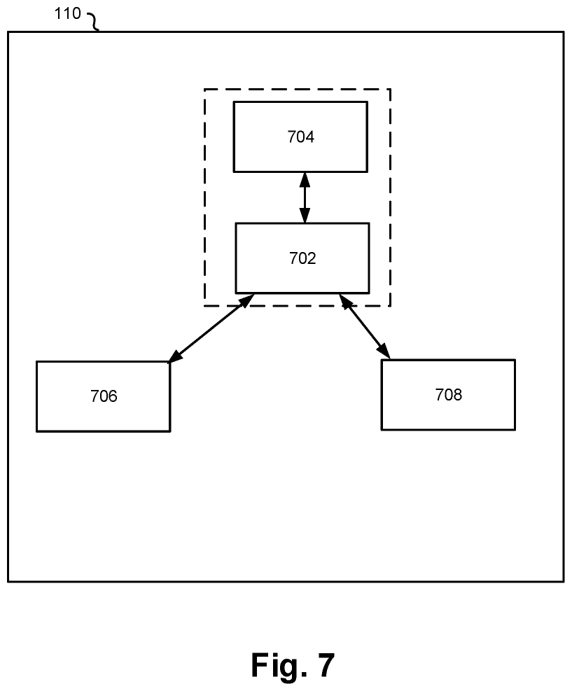

FIG. 7 shows an alternative implementation of the transaction processing server 110 (i.e., the computer system 1300). In the alternative implementation, the transaction processing server 110 may be generally described as a physical device comprising at least one processor 702 and at least one memory 704 including computer program codes. The at least one memory 704 and the computer program codes are configured to, with the at least one processor 702, cause the transaction processing server 110 to perform the operations described in sub-processes 220, 320, and 250. The transaction processing server 110 may also include a transaction processing module 706 and a user account module 708. The memory 704 stores computer program code that the processor 702 compiles to have each of the modules 706 and 708 performs their respective functions.

With reference to FIG. 1, the transaction module 706 performs the function of communicating with the devices 102, 103, 104 to receive transactions and to transmit data (e.g., an authorization to use a user account, etc.).

With reference to FIG. 1, the user account module 708 performs the function of registering user accounts and performing sub-processes 220, 320, and 250.

### INDUSTRIAL APPLICABILITY

The arrangements described are applicable to the computer and data processing industries and particularly for the conducting a transaction across a plurality of devices.

The foregoing describes only some embodiments of the present invention, and modifications and/or changes can be made thereto without departing from the scope and spirit of the invention, the embodiments being illustrative and not restrictive.

1. A server for processing a transaction using a plurality of devices, the server comprising:
at least one processor; and
at least one memory including computer program code;
the at least one memory and the computer program code configured to, with the at least one processor, cause the server at least to:
receive, from a second device, a request to continue with the transaction, the transaction being initiated and postponed by a first device;
determine whether the second device is associated with a user account that is associated with the first device; and
transmit, to the second device, details relating to the postponed transaction based on the determination of whether the second device is associated with the user account to enable the second device to further process the transaction.

2. The server of claim 1, wherein the server is further configured to:
receive, from the first device, a request to initiate the transaction using the user account;
determine whether the first device is associated with the user account; and
initiate the transaction using the user account based on the determination whether the first device is associated with the user account.

3. The server of claim 2, wherein the server is further configured to:
in response to determining that the first device or the second device is not associated with the user account, pair the first device or the second device with the user account based on an authorization of the pairing, the authorization of the pairing is associated with a device that is associated with the user account, wherein the paired first device or the paired second device is enabled to process the transaction.

4. The server of claim 3, wherein the server is further configured to:
transmit, to the device that is associated with the user account, a request to pair the first device or the second device with the user account; and
receive the authorization of the pairing from the device that is associated with the user account.

5. The server of claim 3, wherein the server is further configured to:
transmit, to the first device or the second device respectively, a request to pair the first device or the second device with the user account; and
receive, from the first device or the second device, the authorization of the pairing.

6. The server of claims 3, wherein the server is further configured to:
disassociate the paired first device or the paired second device from the user account in response to the transaction being postponed or completed.

7. The server of claims 1, wherein the server is further configured to:
determine whether to postpone the transaction that is initiated by the first device; and
postpone the transaction based on the determination whether to postpone the transaction.

8. The server of claim 7, wherein the server is further configured to:
receive, from the first device, a request to postpone the transaction, wherein the server determines to postpone the transaction based on the received request.

9. The server of claim 8, wherein the request from the first device is from a user input received at the first device or a determination from the first device that the transaction has been inactive for a period of time.

10. The server of claim 7, wherein the server is further configured to:
determine that the transaction has been inactive for a period of time, wherein the server determines to postpone the transaction based on the determination that the transaction has been inactive for a period of time.

11. A method of processing a transaction using a plurality of devices, the method comprising:
receiving, from a second device, a request to continue with the transaction, the transaction being initiated and postponed by a first device;
determining whether the second device is associated with a user account that is associated with the first device; and
transmitting, to the second device, details relating to the postponed transaction based on the determination of whether the second device is associated with the user account to enable the second device to further process the transaction.

12. The method of claim 11, the method further comprising:
receiving, from the first device, a request to initiate the transaction using the user account;
determining whether the first device is associated with the user account; and
initiating the transaction using the user account based on the determination whether the first device is associated with the user account.

13. The method of claim 12, the method further comprising:
in response to determining that the first device or the second device is not associated with the user account, pairing the first device or the second device with the user account based on an authorization of the pairing received from a device that is associated with the user account, wherein the paired first device or the paired second device is enabled to process the transaction.

14. The method of claim 13, the method further comprising:
transmitting, to the device that is associated with the user account, a request to pair the first device or the second device with the user account; and
receiving the authorization of the pairing from the device that is associated with the user account.

15. The method of claim 13, the method further comprising:
transmitting, to the first device or the second device respectively, a request to pair the first device or the second device with the user account; and
receiving the authorization of the pairing from the first device or the second device.

16. The method of any one of claims 13, the method further comprising:
disassociating the paired first device or the paired second device from the user account in response to the transaction being postponed or completed.

17. The method of claim 11, the method further comprising:
determining whether to postpone the transaction that is initiated by the first device; and
postponing the transaction based on the determination whether to postpone the transaction.

18. The method of claim 17, the method further comprising:
receiving, from the first device, a request to postpone the transaction, wherein the determination to postpone the transaction is based on the received request.

19. The method of claim 18, wherein the request from the first device is from a user input received at the first device or a determination from the first device that the transaction has been inactive for a period of time.

20. The method of claim 17, the method further comprising:
determining that the transaction has been inactive for a period of time, wherein the determination to postpone the transaction is based on the determination that the transaction has been inactive for a period of time.
